(19) United States
(12) Patent Application Publication
(10) Pub. No.: US 2024/0100501 A1
(43) Pub. Date: Mar. 28, 2024

(54) COMPOSITION OF SMALL PARTICLE SIZE ACTIVATED CARBON FOR IMMOBILIZING INORGANIC COMPOUNDS FROM CONTAMINATED MEDIUMS

(71) Applicant: ADA Carbon Solutions, LLC, Greenwood Village, CO (US)

(72) Inventors: Micala Mitchek, Denver, CO (US); Joseph M. Wong, Castle Pines, CO (US); Robert Huston, Longmont, CO (US); David Park, Naperville, IL (US); Lingyan Song, Englewood, CO (US); Mowen Li, Highlands Ranch, CO (US)

(21) Appl. No.: 18/472,588

(22) Filed: Sep. 22, 2023

Related U.S. Application Data
(60) Provisional application No. 63/410,028, filed on Sep. 26, 2022.
(60) Provisional application No. 63/431,555, filed on Dec. 9, 2022.

(51) Int. Cl. B01J 20/20; B01J 20/28; C02F 1/28

(52) U.S. Cl. CPC B01J 20/20; B01J 20/28004; B01J 20/28059; B01J 20/28071; C02F 1/281; C02F 2101/108

(57) ABSTRACT

The present disclosure is directed to a multi-functional composition including activated carbon that is useful for injection or other application into soil or groundwater for removal (e.g., via adsorption) of inorganic contaminants in a contaminated plume. The composition of activated carbon may include physical and chemical properties to enhance the mechanism of contaminant physisorption and chemisorption including enhanced electrostatic interactions with contaminants. The multi-functional composition may further include one or more second materials (e.g., contaminant-selective agents) which comprise one or more compounds that improve the activated carbon's ability to sequester or otherwise immobilize inorganic contaminants in a subsurface environment.

### CROSS REFERENCES

This application claims priority to U.S. Provisional Patent Application No. 63/410,028, filed Sep. 26, 2022, entitled “COMPOSITION OF SMALL PARTICLE SIZE ACTIVATED CARBON FOR ADSORBING INORGANIC COMPOUNDS FROM GROUNDWATER,” and U.S. Provisional Patent Application No. 63/431,555, filed Dec. 9, 2022, entitled “NOVEL ACTIVATED CARBONS FOR SEQUESTERING CONTAMINANT COMPOUNDS FROM GROUNDWATER”, each of which is incorporated herein by reference in its entirety.

### FIELD

The disclosure relates generally to treatment of contaminated mediums (e.g., wastewater, ground water, soil) and particularly to sorbent compositions useful for the treatment of contaminated mediums, and to methods of making and using the sorbent compositions.

### BACKGROUND

Impending regulations for coal combustion residuals (CCRs) include requirements for groundwater monitoring and treatment in the case that groundwater quality standard exceedances exist. The CCR Rule requires remediation of 16 constituents should their concentrations in the groundwater exceed groundwater protection standards (GWPS). In addition to the 16 constituents, pending amendments to the CCR Rule would also create treatment requirements for boron. Among others, constituents of high importance relative to the CCR Rule include arsenic (As), cobalt (Co), lithium (Li), molybdenum (Mo), and boron (B). These are particularly important because they are abundant in CCR-impacted groundwater, are mobile in groundwater, and generally lack cost-effective treatment options.

A boron selective activated carbon composition was developed and tested at the lab scale by ADA Carbon Solutions, LLC (ADA) in 2016 through 2018 to obtain technology solutions for cleanup of groundwater impacted by CCRs. These formulations are covered in the United States Patent Publication Application No. US 2018/0170773, which is incorporated by reference herein. The ADA-developed boron selective adsorbent has shown promise in successfully removing boron as well as some other background constituents of concern from contaminated waters. Application of the boron selective adsorbent was targeted originally in the Powdered Activated Carbon (PAC) or Granular Activated Carbon (GAC) forms for Permeable Reactive Barrier and Pump-and-Treat processes.

There is a need for a product adaptable for in-situ injection treatment to immobilize, sequester, and/or remove constituents, such as CCRs, from contaminated mediums. Additionally, there is a need for a product capable of targeting contaminants other than boron, such as in addition to boron.

### SUMMARY

These and other needs are addressed by the various embodiments and configurations of the present disclosure. This disclosure provides a colloidal carbon product (CCP) which is suitable for low-pressure subsurface injection to achieve in situ sequestration of boron. Also disclosed are activated carbon-based products (e.g., colloidal, granular, powdered) with specific functionalities that make them amenable to sequestering or otherwise removing additional contaminants (e.g., inorganic contaminants such as CCR Rule constituents).

The present disclosure provides a multi-functional composition that includes activated carbon for immobilization and/or removal of contaminants in an aqueous or solid medium, such as groundwater, soil, or other effluent comprising liquid- or solid-phase contaminants. The multi-functional composition can also be used for solid contaminant immobilization and/or removal, such as from contaminated soil. In some embodiments, a multi-functional composition includes activated carbon as a base sorbent material and one or more contaminant-selective agents. The contaminant-selective agents can be one or more of: a compound or a group of compounds comprising 1,2 hydroxyl groups, 1,2 carboxyl groups, 1,2 carbonyl groups, and mixtures thereof, a compound comprising metal oxides, layered double hydroxides, metal sulfides, zero valent iron, and mixtures thereof, a compound comprising phenolic hydroxyl and/or carboxylic groups bonded to aromatic rings and mixtures thereof, and any other compound comprising an anionic functional group and mixtures thereof. The contaminant-selective agents may be combined with the base material before or while being applied to a contaminated site, or both. The contaminant-selective agents may be combined with the base material before or after activation of the base material, or both. The contaminant-selective agents can be added to the activated carbon or precursor thereof in a wet or dry formulation at elevated temperature or at ambient temperature. While not wishing to be bound by any theory, it is believed that the contaminant-selective agents are attracted to the activated carbon by a combination of van der Waals forces, chemically functional interactions, and pore adsorption.

Exemplary contaminants comprise elemental and speciated metals, more specifically alkali metals, alkaline earth metals, transition metals, post transition metals, actinides, lanthanides, and metalloids, and even more specifically arsenic (As), cobalt (Co), lithium (Li), molybdenum (Mo), and boron (B) and compounds thereof.

The multi-functional composition includes diffusion pores, interior surfaces of which further include sequestration pores. The pore sizes of the diffusion and sequestration pores are selected to substantially maximize rapid sequestration of the target contaminant. The diffusion pore size, for example, can be typically about 10 or more and more typically about 25 or more times larger than the molecular size of the target contaminant, and the sequestration pore size can be typically no more than about five and more typically no more than about 2.5 times the molecular size of the target contaminant. While not wishing to be bound by any theory, it is believed that the diffusion pores funnel the target contaminant particles for adsorption by the sequestration pores through capillary action. Capillary action is the ability of a liquid to flow into narrow spaces without the assistance of external forces.

In some embodiments, a multi-functional composition of matter for immobilizing inorganic constituents in contaminated mediums, comprises activated carbon particles, wherein: about 50% by weight of the activated carbon particles are less than about 3 micrometers, about 90% by weight of the activated carbon particles are less than about 5 micrometers, a particle number density of the multi-functional composition of matter is at least about a trillion particles per gram, and an external surface area density of the multi-functional composition of matter is at least about 3 square meters per gram.

In some embodiments, a multi-functional composition of matter for immobilizing inorganic constituents in contaminated mediums, comprises activated carbon particles and a contaminant-selective agent, wherein: the activated carbon particles comprise between about 20 wt. % and about 99.5 wt. % of the multi-functional composition of matter, and the contaminant-selective agent comprises between about 0.5 wt. % and about 80 wt. % of the multi-functional composition of matter.

In some embodiments, a method of immobilizing inorganic constituents from contaminated mediums, comprises: contacting a multi-functionalized activated carbon sorbent with water to form a slurry, wherein the multi-functionalized activated carbon sorbent comprises activated carbon particles and a contaminant-selective agent; and injecting the slurry into the contaminated medium.

The activated carbon particles may comprise between about 30 wt. % and about 90 wt. % of the multi-functional composition of matter, between about 40 wt. % and about 80 wt. % of the multi-functional composition of matter, between about 50 wt. % and about 75 wt. % of the multi-functional composition of matter, between about 10 wt. % and about 70 wt. % of the multi-functional composition of matter, between about 20 wt. % and about 60 wt. % of the multi-functional composition of matter, or between about 25 wt. % and about 50 wt. % of the multi-functional composition of matter.

In embodiments, about 50% by weight of the activated carbon particles are less than about 3 micrometers, less than about 2 micrometers, or less than about 1 micrometer.

In embodiments, about 90% by weight of the activated carbon particles are less than about 5 micrometers, less than about 4 micrometers, or less than about 3 micrometers.

A particle number density of the multi-functional composition of matter may be at least about a trillion particles per gram.

An external surface area density of the multi-functional composition of matter may be at least about 3 square meters per gram, or at least about 1.5 square meters per gram.

In embodiments, the multi-functional composition of matter comprises at least about 50 wt. % and not greater than about 97 wt. % fixed carbon. In embodiments, the multi-functional composition of matter comprises at least about 1.5 wt. % and not greater than 50 wt. % minerals.

The activated carbon particles comprise a sum of micropore volume plus mesopore volume that is at least about 0.1 cc/g, at least about 0.2 cc/g.

The activated carbon particles comprise a ratio of micropore volume-to-mesopore volume that is at least about 0.35 and not greater than about 3, is at least about 0.4 and not greater than about 2.5, or is at least about 0.45 and not greater than about 1.9

The activated carbon particles comprise a thermal gravimetric analysis (TGA) weight loss, between 400-750° C., of less than about 5 wt. %, less than about 4 wt. %, or less than about 3 wt. %.

The multi-functional composition of matter may be combined with water to form a slurry, and the slurry may be alkaline comprising a pH greater than about 10.

The slurry may comprise a multi-functional rheology additive, dispersion aid, or both at a mass ratio of activated carbon particles to multi-functional rheology additive between about 0.95:0.05 and about 0.50:0.50 or between about 0.90:0.10 and about 0.70:0.30.

The multi-functional rheology additive, dispersion aid, or both may be selected from the group comprising carboxymethyl cellulose, petroleum sulfonates, polyacrylates, polycarboxylates, polynaphthalene sulfonates, sodium lignosulfonates, Hydroxy ethyl cellulose (HEC), Methyl cellulose (MC), Methyl hydroxy ethyl cellulose (MHEC), hydroxy propyl methyl cellulose (HPMC), Hydroxy propyle cellulose (HPC), Ethyl cellulose (EC), Carbomer (polyacrylic acid), and Guar.

The contaminant-selective agent may be a compound selected from a group of compounds comprising 1,2 hydroxyl groups, 1,2 carboxyl groups, 1,2 carbonyl groups, and mixtures thereof, or selected from a group of compounds comprising a metal oxide, a layered double hydroxide, a metal sulfide, a zero valent iron, and mixtures thereof, or selected from a group of compounds comprising a phenolic hydroxyl, a carboxylic group bonded to aromatic rings, and mixtures thereof, or comprises an anionic functional group, or combinations thereof.

In embodiments, the multi-functional composition of matter comprises multiple (e.g., a second) contaminant-selective agent selected from a group of compounds comprising 1,2 hydroxyl groups, 1,2 carboxyl groups, 1,2 carbonyl groups, a metal oxide, a layered double hydroxide, a metal sulfide, a zero valent iron, a phenolic hydroxyl, a carboxylic group bonded to aromatic rings, an anionic functional group, or mixtures thereof.

The multi-functional composition of matter and/or the activated carbon particles comprises diffusion pores and sequestration pores having pore sizes selected based on a molecular size of an inorganic contaminant.

The contaminant-selective agent may increase the ability of the activated carbon particles to immobilize the inorganic constituents from the contaminated mediums.

The contaminated mediums may comprise soil, groundwater, or both. The inorganic constituents may comprise arsenic, boron, cobalt, lithium, molybdenum, combinations thereof, or other coal combustion residuals.

The present invention can achieve a number of advantages depending on one or more target contaminants of interest. The present invention can provide a multi-functional composition comprising at least a base activated carbon material and, in some cases, one or more contaminant-selective agents tailored to target immobilization and/or removal of one or more contaminants by controlling the chemical and/or physical properties of the multi-functional composition based on the chemical and/or physical properties of the target contaminant(s). Such a multi-functional composition is not only effective in immobilizing and/or removing the targets contaminant(s) from groundwater and soil but also can be produced much more inexpensively and at a much higher yield than conventional activated carbon sorbents.

These and other advantages will be apparent from the disclosure of the aspects, embodiments, and configurations contained herein.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below.

A number of variations and modifications of the invention can be used. It would be possible to provide for some features of the invention without providing others. The embodiments and configurations described herein are neither complete nor exhaustive. As will be appreciated, other embodiments are possible utilizing, alone or in combination, one or more of the features set forth above or described in detail below.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together. When each one of A, B, and C in the above expressions refers to an element, such as X, Y, and Z, or class of elements, such as X₁-Xₙ, Y₁-Yₘ, and Z₁-Zₒ, the phrase is intended to refer to a single element selected from X, Y, and Z, a combination of elements selected from the same class (e.g., X₁ and X₂) as well as a combination of elements selected from two or more classes (e.g., Y₁ and Zₒ).

It is to be noted that the term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

“Absorption” is the incorporation of a substance in one state into another of a different state (e.g. liquids being absorbed by a solid or gases being absorbed by a liquid). Absorption is a physical or chemical phenomenon or a process in which atoms, molecules, or ions enter some bulk phase—gas, liquid or solid material. This is a different process from adsorption, since molecules undergoing absorption are taken up by the volume, not by the surface (as in the case for adsorption).

“Adsorption” is the adhesion of atoms, ions, biomolecules, or molecules of gas, liquid, or dissolved solids to a surface. This process creates a film of the adsorbate (the molecules or atoms being accumulated) on the surface of the adsorbent. It differs from absorption, in which a fluid permeates or is dissolved by a liquid or solid. Similar to surface tension, adsorption is generally a consequence of surface energy. The exact nature of the bonding depends on the details of the species involved, but the adsorption process is generally classified as physisorption (characteristic of weak van der Waals forces)) or chemisorption (characteristic of covalent bonding). It may also occur due to electrostatic attraction.

A “mill” refers to any facility or set of facilities that process a metal-containing material, typically by recovering, or substantially isolating, a metal or metal-containing mineral from a feed material. Generally, the mill includes an open or closed comminution circuit, which includes crushers or autogenous, semi-autogenous, or non-autogenous grinding mills.

A “sorbent” is a material that sorbs another substance; that is, the material has the capacity or tendency to take it up by sorption.

“Sorb” means to take up a liquid or a gas by sorption.

“Sorption” refers to adsorption and absorption, while desorption is the reverse of adsorption.

“Contaminants” as used herein, refers to contaminants found in contaminated soil and groundwater, including inorganic contaminants such as coal combustion residuals (CCRs), such as arsenic (As), cobalt (Co), lithium (Li), molybdenum (Mo), and boron (B).

“Sequestration pores” refer to pores of a multi-functional composition of matter, and may include micropores.

“Diffusion pores” refer to pores of a multi-functional composition of matter, and may otherwise be referred to a transportation pores, and may include mesopores.

“Activated carbon” or “AC” refers to an amorphous carbon that has been treated with steam and heat to exhibit strong affinity for adsorbing target contaminants.

“Fixed carbon” refers to the remaining carbon after carbonization process and the activation process, demonstrated by: % Fixed carbon=100%−(% volatile matter content−% ash content).

“Immobilization” as used herein with reference to contaminants, refers to adsorption, sequestration, precipitation, capture, or a combination thereof of the contaminants.

Unless otherwise noted, all component or composition levels are in reference to the active portion of that component or composition and are exclusive of impurities, for example, residual solvents or by-products, which may be present in commercially available sources of such components or compositions.

All percentages and ratios are calculated by total composition weight, unless indicated otherwise.

It should be understood that every maximum numerical limitation given throughout this disclosure is deemed to include each and every lower numerical limitation as an alternative, as if such lower numerical limitations were expressly written herein. Every minimum numerical limitation given throughout this disclosure is deemed to include each and every higher numerical limitation as an alternative, as if such higher numerical limitations were expressly written herein. Every numerical range given throughout this disclosure is deemed to include each and every narrower numerical range that falls within such broader numerical range, as if such narrower numerical ranges were all expressly written herein. By way of example, the phrase from about 2 to about 4 includes the whole number and/or integer ranges from about 2 to about 3, from about 3 to about 4 and each possible range based on real (e.g., irrational and/or rational) numbers, such as from about 2.1 to about 4.9, from about 2.1 to about 3.4, and so on.

As used herein, unless otherwise specified, the terms “about,” “approximately,” etc., when used in relation to numerical limitations or ranges, mean that the recited limitation or range may vary by up to 10%. By way of non-limiting example, “about 750” can mean as little as 675 or as much as 825, or any value therebetween. When used in relation to ratios or relationships between two or more numerical limitations or ranges, the terms “about,” “approximately,” etc. mean that each of the limitations or ranges may vary by up to 10%; by way of non-limiting example, a statement that two quantities are “approximately equal” can mean that a ratio between the two quantities is as little as 0.9:1.1 or as much as 1.1:0.9 (or any value therebetween), and a statement that a four-way ratio is “about 5:3:1:1” can mean that the first number in the ratio can be any value of at least 4.5 and no more than 5.5, the second number in the ratio can be any value of at least 2.7 and no more than 3.3, and so on.

### BRIEF DESCRIPTION OF THE DRAWINGS

The accompanying drawings are incorporated into and forms a part of the specification to illustrate several examples of the present disclosure. These drawings, together with the description, explains the principles of the disclosure. The drawings simply illustrate preferred and alternative examples of how the disclosure can be made and used and is not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 depicts plots of residual concentrations (y-axis) for various base carbons versus media dosages (x-axis), according to embodiments of the present disclosure;

FIG. 2 depicts media dose (i.e., sorbent dose) removal plots and pH plots for two example base activated carbon products, according to embodiments of the present disclosure;

FIG. 3 depicts plots of residual molybdenum (Mo) concentrations (y-axis) for various multi-functional composition formulations versus media dosages (x-axis), according to embodiments of the present disclosure;

FIG. 4 depicts plots of residual lithium (Li) concentrations (y-axis) for various multi-functional composition formulations versus media dosages (x-axis), according to embodiments of the present disclosure;

FIG. 5 depicts plots of residual boron (B) concentrations (y-axis) for various multi-functional composition formulations versus media dosages (x-axis), according to embodiments of the present disclosure;

FIG. 6 depicts plots of residual cobalt (Co) concentrations (y-axis) for various multi-functional composition formulations versus media dosages (x-axis), according to embodiments of the present disclosure;

FIG. 7 depicts plots of residual cadmium (Cd) concentrations (y-axis) for various multi-functional composition formulations versus media dosages (x-axis), according to embodiments of the present disclosure;

FIG. 8 depicts plots of contaminant concentrations (y-axis) for various multi-functional composition formulations versus activated carbon dosages (x-axis), according to embodiments of the present disclosure; and

FIGS. 9A and 9B depict Freundlich Isotherm plots of contaminant adsorptions (y-axis) versus contaminant equilibrium concentrations (x-axis), according to embodiments of the present disclosure.

### DETAILED DESCRIPTION

Unless defined otherwise, all technical and scientific terms used herein have the same meaning as is commonly understood by one of ordinary skill in the art. All patents, applications, published applications, and other publications to which reference is made herein are incorporated by reference in their entirety. If there is a plurality of definitions for a term herein, the definition provided in the Summary prevails unless otherwise stated.

The present disclosure is directed to multi-functional compositions, methods for making the multi-functional compositions and methods for using the multi-functional compositions, e.g., to remove, adsorb, immobilize, and/or sequester) inorganic contaminant species (e.g., CCRs) from contaminated mediums. Various embodiments of a multi-functional composition of matter comprising activated carbon are provided that are particularly useful when applied (e.g., injected) to contaminated mediums, such as soil and/or groundwater, or another effluent comprising liquid- or solid-phase contaminants to rapidly and efficiently capture and/or remove contaminants. The multi-functional compositions are capable of removing inorganic species from mediums and also have a high capacity for contaminant removal (e.g., sequestration).

Exemplary contaminants comprise elemental and speciated inorganic materials such as metals, or more specifically alkali metals, alkaline earth metals, transition metals, post transition metals, actinides, lanthanides, and metalloids, and even more specifically arsenic (As), cobalt (Co), lithium (Li), molybdenum (Mo), and boron (B) and compounds thereof. Exemplary contaminants may further include other regulated contaminants in the CCR regulations not explicitly expressed, including antimony, barium, beryllium, bromate, cadmium, chloramines, chlorine, chlorite, chromium, cyanide, fluoride, lead, mercury, nitrate, nitrite, selenium, and thallium and compounds thereof.

The composition of the multi-functional composition of matter and/or the activated carbon may include physical and chemical properties to enhance the mechanism of contaminant physisorption and chemisorption including enhanced adsorption kinetics through manipulation of particle surface area, enhanced capacity and selectivity through controlled pore size distribution, and enhanced electrostatic and hydrophobic interactions with contaminants.

Broadly characterized, the multi-functional compositions disclosed herein may include a base material (e.g., a base sorbent material) having a relatively high porosity and a high surface area, and in some embodiments, one or more contaminant-selective agents. A contaminant-selective agent may be used in combination with the base material to enhance the ability of the base material to target contaminants for removal.

In some embodiments, a multi-functional composition includes activated carbon as a base material. The multi-functional composition and/or the activated carbon particles of the multi-functional composition of matter may be uniform or vary in size. Examples of sorbent activated carbon materials include powdered activated carbon (PAC), granular activated carbon (GAC), colloidal carbon products (CCP), reactivated versions of the preceding carbons, and combinations thereof.

In certain embodiments, the multi-functional composition (e.g., the multi-functional composition as a whole and/or a base material, such as activated carbon particles, of the multi-functional composition) comprises particles having a relatively small median average particle size (D50), e.g., to enhance the efficiency of contaminant removal by the multi-functional composition. In one characterization, the median average particle size of the multi-functional composition is not greater than about 10 μm, or more specifically not greater than about 8 μm, or more specifically not greater than about 6 μm, or even more specifically not greater than about 5 μm. Characterized differently, the median average particle size of the multi-functional composition may range from about 0.1 to about 10 μm and more typically from about 0.5 to about 5 μm. In some applications, it may be desirable to utilize a multi-functional composition having a median average or a majority (e.g., greater than about 50%) particle size of not greater than about 6 μm, not greater than about 5 μm, not greater than about 4 μm, not greater than about 3 μm, not greater than about 2 μm, and even not greater than about 1 μm. One example of such a multi-functional composition is or comprises colloidal activated carbon.

In embodiments, at least most (i.e., at least about 50 wt. %) of the activated carbon particles by weight are less than about 10 micrometers (μm), or more particularly less than about 8 μm, or more particularly less than about 5 μm, or more particularly less than about 4 μm, or more particularly less than about 3 μm, or more particularly less than about 2 μm, or more particularly less than about 1 μm. In embodiments, at least about 30 wt. %, or more particularly at least about 40 wt. %, or more particularly at least about 50 wt. % of the activated carbon particles are less than about 2 μm, or more particularly less than about 1 μm. In embodiments, at least about 50 wt. %, or more particularly at least about 60 wt. %, or more particularly at least about 70 wt. %, or more particularly at least about 80 wt. %, or more particularly at least about 90 wt. % of the activated carbon particles are less than about 5 μm, or more particularly less than about 4 μm, or more particularly less than about 3 μm. In embodiments, at least about 50 wt. % of the activated carbon particles are less than about 2 μm and at least about 90 wt. % of the activated carbon particles are less than about 5 μm. In embodiments, at least about 50 wt. % of the activated carbon particles are less than about 1 μm and at least about 90 wt. % of the activated carbon particles are less than about 3 μm.

In one characterization, the median average or a majority of the particle size of the multi-functional composition is not greater than about 350 μm, such as not greater than about 200 μm, not greater than 100 μm, not greater than 75 μm, not greater than 50 μm, such as not greater than about 30 μm, or even not greater than about 25 μm. In some applications, it may be desirable to utilize a multi-functional composition having a median average particle size of not greater than about 20 μm, not greater than about 15 μm, and even not greater than about 12 μm. In some applications, it may be desirable to utilize a multi-functional composition having a median average particle size ranging typically from more than about 10 to about 350 μm and more typically from about 15 to about 200 μm Characterized in another way, the median particle size of the multi-functional composition may be at least about 5 μm, such as at least about 6 μm, at least about 8 μm, or at least about 10 μm, or even at least about 12 μm. One example of such a multi-functional composition is or comprises powdered activated carbon.

Depending upon the application of the sorbent composition, it may be desirable to utilize multi-functional compositions having a larger average size, e.g., in the form of agglomerates or aggregates, e.g., granules. For example, the multi-functional composition may be in the form of granules having a median size of at least about 0.2 mm, such as at least about 0.3 mm. Typically, the granules will have a median size of not greater than about 3.0 mm, such as not greater than about 2.5 mm. In another characterization, the granules may have a mesh size of about 8×20, about 8×30, or about 20×40 in the Tyler mesh series. In one characterization, the granules comprise activated carbon, i.e., granulated activated carbon.

D50 median average particle size may be measured using techniques such as light scattering techniques (e.g., using a Saturn DigiSizer II, available from Micromeritics Instrument Corporation, Norcross, GA), or any other known method.

In another example, the multi-functional compositions may be in the form of extrudates, e.g., pellets that are formed by extrusion or a similar process. For example, the multi-functional compositions may be in the form of extruded pellets of activated carbon.

Although free-flowing particles, granules or extrudates of the multi-functional composition are described above, the use of larger, rigid or semi-rigid porous bodies (e.g., porous honeycomb structures) comprising physical and chemical properties to enhance the mechanism of contaminant physisorption and chemisorption are also contemplated by the present disclosure.

The particle number density of the activated carbon particles of the multi-functional composition of matter disclosed herein is at least about a trillion particles per gram. The external surface area density of the multi-functional composition of matter is at least about 5 square meters per gram, or more particularly at least about 3 square meters per gram, or more particularly at least about 2 square meters per gram, or even more particularly about 1.5 square meters per gram. The particle number density and external surface area density may be determined by the Micromeritics Saturn DigiSizer II method, with computations assuming median representative spherical particles, or any other known method.

The multi-functional composition includes diffusion pores (i.e., transportation pores, mesopores), interior surfaces of which further include sequestration pores (i.e., micropores, small mesopores). The pore sizes of the diffusion and sequestration pores are selected to substantially maximize sequestration of the target contaminant(s). The diffusion pore size, for example, can be typically about 10 or more and more typically about 25 or more times larger than the molecular size of the target contaminant, and the sequestration pore size can be typically no more than about five and more typically no more than about 2.5 times the molecular size of the target contaminant. Micropores typically have a diameter size in the range of about 0-20 Angstroms, mesopores typically have a diameter size in the range of about 20-500 Angstroms, and macropores typically have a diameter size in the range of about 500-1000 Angstrom. Diffusional pores typically have a diameter size in the range of about 20-150 Angstrom. While not wishing to be bound by any theory, it is believed that the diffusion pores capture and transport the target contaminant particles for adsorption by the sequestration pores through capillary action. Capillary action is the ability of a liquid to flow into narrow spaces without the assistance of external forces. In some applications, the pore size distribution is multi-modal (e.g., bimodal).

In one characterization, the composition has a relatively high total pore volume and a well-controlled distribution of pores, particularly among the mesopores (i.e., from 20 Å to 500 Å width) and the micropores (i.e., not greater than 20 Å width). A well-controlled distribution of micropores and mesopores is desirable for effective removal of contaminants from a contaminated aqueous stream.

In this regard, the sum of micropore volume plus mesopore volume may be at least about 0.1 cc/g, such as at least 0.3 cc/g, or at least about 0.5 cc/g. The micropore volume of the composition may be at least about 0.05 cc/g, such as at least about 0.1 cc/g, or at least about 0.3 cc/g. Further, the small mesopore volume (20-150 A) of the composition may be at least about 0.05 cc/g, such as at least about 0.1 cc/g, or at least about 0.15 cc/g. In an embodiment, the ratio of micropore volume to small-mesopore volume may be at least about 1, such as 1.2, 1.3, 1.4, or 1.5 and may be not greater than about 3.0, such as 2.5, or 2. In an embodiment, the ratio of micropore volume to small-mesopore volume may be between about 1.0 to 2.0, and particularly about 1.5. Such levels of micropore volume relative to mesopore volume may advantageously enable efficient capture and sequestration of contaminant species by the multi-functional composition. Pore volumes may be measured using gas adsorption techniques (e.g., N₂ adsorption) using instruments such as a TriStar II Surface Area Analyzer 3020 or ASAP 2020 (Micromeritics Instruments Corporation, Norcross, GA, USA), or any other known method.

In another characterization, the multi-functional composition (e.g., the multi-functional composition as a whole and/or a base material of the multi-functional composition (e.g., the activated carbon) has a relatively high surface area. In one such characterization, the base sorbent material may have a surface area of at least about 350 m²/g, such as at least about 400 m²/g, at least about 500 m²/g, at least about 600 m²/g, or even at least about 1000 m²/g. Surface area may be calculated using the Brunauer-Emmett-Teller (BET) theory or Density Functional Theory (DFT) equation that models the physical adsorption of a monolayer of nitrogen gas molecules on a solid surface and serves as the basis for an analysis technique for the measurement of the specific surface area of a material. BET surface area may be measured using the Micromeritics TriStar II 3020 or ASAP 2020 (Micromeritics Instrument Corporation, Norcross, GA), or other known methods.

Ball pan hardness provides a measure of the degradation resistance or “hardness” of activated carbons. The ball pan hardness of the multi-functional composition of the present disclosure when lignite is used as the predominant feed material is less than about 98, or more particularly less than about 90, or more particularly less than about 85, or more particularly less than about 80, or even more particularly less than about 75. The ball pan hardness of the multi-functional composition of the present disclosure when bituminous or subbituminous coal is used as the predominant feed material is at least about 70, or more particularly at least about 80, or more particularly at least about 90 but less than about 100, or more particularly less than about 99.5, or more particularly less than about 99.

In embodiments, the multi-functional composition of the present disclosure comprises at least about 30 wt. %, or more particularly at least about 40 wt. %, or more particularly at least about 50 wt. % of fixed carbon and not greater than about 100 wt. %, or more particularly not greater than about 95 wt. %. Stated differently, the multi-functional composition comprises about 30-100 wt. % of fixed carbon, or more particularly about 40-98 wt. % of fixed carbon, or even more particularly about 50-95 wt. % of fixed carbon.

The multi-functional composition of the present disclosure comprises at least about 1 wt. %, or more particularly about 1.5 wt. %, or more particularly about 2 wt. %, or more particularly at least about 5 wt. %, and not greater than about 80 wt. %, or more particularly not greater than about 70 wt. %, or more particularly not greater than about 60 wt. %, more particularly not greater than about 50 wt. % of minerals. Stated differently, the multi-functional composition comprises about 0-80 wt. % of minerals, more particularly about 1-60 wt. % of minerals, or even more particularly about 1.5-50 wt. % of minerals. Minerals included in the multi-functional composition may include aluminosilicates, metal oxides, metal carbonates, etc.

Although the discussions herein primarily refers to the use of porous carbonaceous particles as the base sorbent material of the multi-functional composition, specifically activated carbon, the multi-functional compositions of the present disclosure are not so limited. The activated carbon may be derived from a variety of sources (e.g., feedstocks), including anthracite coal, bituminous coal, lignite coal, coconut shells, wood, and the like. In one characterization, the activated carbon is derived from a bituminous and/or sub-bituminous coal feedstock.

In embodiments, the activated carbon of the multi-functional composition of matter may be derived from coal, and in particular may be derived from lignite coal, bituminous coal, sub-bituminous coal, or a combination thereof. In some embodiments, the multi-functional composition of matter may include mostly lignite-based activated carbon, where the activated carbon of the multi-functional composition comprises at least about 50 wt. %, or more particularly at least about 60 wt. %, or more particularly at least about 70 wt. %, or more particularly at least 80 wt. %, or more particularly at least about 90 wt. %, or more particularly about 100 wt. % lignite-based carbon. In some embodiments, the multi-functional composition of matter may include mostly bituminous-based activated carbon, where the activated carbon of the multi-functional composition comprises at least about 50 wt. %, or more particularly at least about 60 wt. %, or more particularly at least about 70 wt. %, or more particularly at least 80 wt. %, or more particularly at least about 90 wt. %, or more particularly about 100 wt. % bituminous-based carbon. In some embodiments, the multi-functional composition of matter may include mostly sub-bituminous-based activated carbon, where the activated carbon of the multi-functional composition comprises at least about 50 wt. %, or more particularly at least about 60 wt. %, or more particularly at least about 70 wt. %, or more particularly at least 80 wt. %, or more particularly at least about 90 wt. %, or more particularly about 100 wt. % sub-bituminous-based carbon. In some embodiments, the multi-functional composition of matter may comprise a mixture of lignite-based carbon and bituminous and/or sub-bituminous based carbon. For example, the multi-functional composition of matter may comprise mostly lignite-based coal (i.e., at least about 50 wt. %, or at least about 60 wt. %, at least about 70 wt. %, at least about 80 wt. %, at least about 90 wt. %) with the remaining percent being bituminous and/or sub-bituminous-based carbon. Alternatively, the multi-functional composition of matter may comprise mostly bituminous-based coal (i.e., at least about 50 wt. %, or at least about 60 wt. %, at least about 70 wt. %, at least about 80 wt. %, at least about 90 wt. %) with the remaining percent being lignite-based carbon and/or sub-bituminous-based carbon. Alternatively, the multi-functional composition of matter may comprise mostly sub-bituminous-based coal (i.e., at least about 50 wt. %, or at least about 60 wt. %, at least about 70 wt. %, at least about 80 wt. %, at least about 90 wt. %) with the remaining percent being lignite-based carbon and/or bituminous-based carbon.

The activated carbon particles may be manufactured from lignite, subbituminous, and/or bituminous coal. Specifications for lignite coal include a fixed carbon content percentage ranging from about 25 to about 35 wt. % (dry and mineral free), and a volatile matter content ranging from about 5 to about 20 wt. % (dry and mineral free). Specifications for subbituminous coals include a fixed carbon content percentage ranging from more than about 35 to about 55 wt. % (dry and mineral free), and a volatile matter content ranging from about 5 to about 35 wt. % (dry and mineral free). Specifications for bituminous coal include a fixed carbon content percentage ranging from about 65 to about 90 wt. % (dry and mineral free), and a volatile matter content ranging from about 10 to about 45 wt. % (dry and mineral free).

While the activated carbon in the multi-functional composition can be hydrophobic, it typically contains hydrophilic and hydrophobic sites or pores (discussed below) having affinity for contaminates. While not wishing to be bound by any theory, activated carbon is generally constituted by blocks of small size imperfect graphene layers randomly bound into a three-dimensional network, with the free spaces within it constituting the pores. The surface of the carbon is commonly hydrophobic since the interaction with water molecules is weak. Activated carbon commonly contains small amounts of oxygen that increase the affinity towards water. This oxygen is bound to the unsaturated carbon atoms located on the edges of the graphene layers thus leading to a variety of oxygen surface groups. These surface groups are generally not distributed homogeneously on the surface of the carbon, but are primarily concentrated on the sites where the blocks of graphene sheets crosslink. These molecules can leave behind unsaturated carbon atoms which, when in contact with air, chemisorb oxygen, thus leading to the formation of new oxygen surface groups. In applications where the interaction of the carbon with polar molecules has to be reduced or in which an activated carbon with low affinity for water is required, the formation of these oxygen surface groups should be reduced to a minimum because water can compete for the adsorption sites and reduce the adsorption capacity for the CCR compounds to be retained.

Thermogravimetric analyzer (TGA) weight loss measures the amount of oxygen functional groups on a carbon-based surface and may be an indicator of hydrophobicity. The higher the TGA weight loss, the higher the amount of oxygen functional groups and the more hydrophilic (or less hydrophobic) a carbon-based surface is. Lignite typically has a TGA weight loss less than about 4%, and more typically less than about 3%, and even more typically less than about 2%. Bituminous-based carbon typically has a TGA weight loss of less than about 4%, more typically less than about 3%, more typically less than about 2%, and even more typically less than about 1%. In some embodiments, the activated carbon of the multi-functional composition of matter disclosed herein has a TGA weight loss of less than about 6 wt. %, or less than about 5 wt. %, less than about 4 wt. %, less than about 3 wt. %, or less than about 2 wt. % (in the temperature range of about 400-750° C.).

In some embodiments, the activated carbon particles comprise at least about 10 wt. %, such as at least about 20 wt. %, at least about 30 wt. %, at least about 40 wt. %, or even at least about 50 wt. % of the multi-functional composition. In some embodiments, the activated carbon particles comprise up to about 99.9 wt. %, such as up to about 99.5 wt. %, up to about 90 wt. %, up to about 80 wt. %, or even at least about 75 wt. % of the multi-functional composition. Stated differently, the activated carbon particles comprise between about 20 to about 99.5 wt. %, or more typically about 30 to 90 wt. %, or more typically about 40 to 80 wt. %, or more typically about 50 to 75 wt. % of the multi-functional composition.

In embodiments, the multi-functional composition in dry form (i.e., no water added) comprises at least about 90 wt. % of the activated carbon, or more particularly at least about 95 wt. % of the activated carbon, or more particularly about 100 wt. % of the activated carbon.

In embodiments, the multi-functional composition is combined with water to form a wet formulation of the multi-functional composition (i.e., a slurry). The wet formulation of the multi-functional composition may comprise between about 0 wt. % and 30 wt. % of activated carbon, or between about 1 wt. % and 20 wt. % of activated carbon, or between about 4 wt. % and 18 wt. % of activated carbon, or between about 6 wt. % and 15 wt. % of activated carbon. In some embodiments, the wet formulation of the multi-functional composition may comprise at least about 5 wt. % activated carbon, or more particularly at least about 10 wt. % activated carbon, or more particularly at least about 15 wt. % activated carbon, or more particularly at least about 20 wt. % activated carbon, or more particularly at least about 25 wt. % activated carbon, or more particularly at least about 30 wt. % activated carbon, or in some embodiments at least about 40 wt. % activated carbon, or in some embodiments at least about 50 wt. % activated carbon.

In embodiments, the wet formulation of the multi-functional composition may comprise between about 0 wt. % and 30 wt. % of multi-functional composition, or between about 1 wt. % and 20 wt. % of multi-functional composition, or between about 4 wt. % and 18 wt. % of multi-functional composition, or between about 6 wt. % and 15 wt. % of multi-functional composition. In some embodiments, the wet formulation of the multi-functional composition may comprise at least about 5 wt. % multi-functional composition, or more particularly at least about 10 wt. % multi-functional composition, or more particularly at least about 15 wt. % multi-functional composition, or more particularly at least about 20 wt. % multi-functional composition, or more particularly at least about 25 wt. % multi-functional composition, or more particularly at least about 30 wt. % multi-functional composition, or in some embodiments at least about 40 wt. % multi-functional composition, or in some embodiments at least about 50 wt. % multi-functional composition.

The weight percent of activated carbon included in the wet formulation may be based on the size of the activated carbon (i.e., granular versus powdered versus colloidal activated carbon). For example, the wet formulation comprising CCP may include a lesser weight percent of activated carbon as compared to a wet formulation comprising powdered activated carbon. In some embodiments, whether the multi-functional composition is combined with water is based on the activated carbon of the multi-functional composition. For example, a multi-functional composition comprising granular activated carbon may not be mixed with water. Similarly, a multi-functional composition comprising powdered activated carbon may be used in the dry form (i.e., with no added water) as well as in a wet form.

In embodiments where the base material of the multi-functional composition is combined with one or more contaminant selective agents, the one or more contaminant selective agents may be a compound or a group of compounds selected from the group comprising 1,2 hydroxyl groups, 1,2 carboxyl groups, 1,2 carbonyl groups and mixtures thereof, a compound comprising metal oxides and hydroxides (e.g., aluminum oxide, titanium oxide, maghemite, goethite, aluminum hydroxide, iron hydroxide, ferric oxyhydroxide, nickel(II) oxide, cobalt(II) oxide, copper(I) oxide, zirconium dioxide, iron(II, III) dioxide, manganese(II) oxide, lead(II) oxide), activated metal oxides (e.g., activated aluminum oxide), layered double hydroxides (i.e., two metals in hydroxide form) (e.g., hydrotalcite, ettringite, hydrocalumite), metal sulfides (e.g., hydrogen sulfide, zinc sulfide, pyrite, iron(II) sulfide, sodium sulfide), iron (e.g., zero valent iron), and mixtures thereof, a compound comprising phenolic hydroxyl and/or carboxylic groups bonded to aromatic rings and mixtures thereof, and any other compound comprising an anionic functional group and mixtures thereof. Metal oxides, layered double hydroxides, metal sulfides, iron, and mixtures thereof may all have a common metal valency, where in the case of zero valent iron, the iron may convert in solution to comprise a valency. The one or more contaminant selective agents may improve the ability of the base material (e.g., activated carbon) to immobilize and/or remove inorganic contaminants in contaminated mediums, such as subsurface mediums.

In some embodiments, the one or more contaminant-selective agents combined with the base material may be based on the one or more contaminants targeted for removal. In a non-limiting example, the base material may be combined with one or more of 1,2 hydroxyl groups, 1,2 carboxyl groups, 1,2 carbonyl groups and mixtures thereof, which may be selective in sequestering or otherwise removing boron. In a non-limiting example, the base material may be combined with one or more metal oxides, layered double hydroxides, metal sulfides, iron, and mixtures thereof, which may selectively attract inorganic constituents, such as CCRs via absorption and/or ionic complexing, but may be selective between CCRs. a non-limiting example, the base material may be combined with organic ligands such as phenolic hydroxyl and/or carboxylic groups bonded to aromatic rings, which may selectively bind some inorganic contaminants over others, such as cobalt.

The removal of contaminants may also be facilitated by the use of surfactants as the contaminant-selective agent, either alone or in combination with one or more of the compounds described above. Useful surfactants may include those with charge classification as anionic, cationic, nonionic or amphoteric. By way of example, cationic salts may enable ion displacement of the cation of the surfactant and reaction with the contaminant species, such as boron, to form a new compound that can be immobilized and/or removed from the liquid stream. Examples of such cationic salts include, but are not limited to, quaternary ammonium salts such as quaternary ammonium chlorides, quaternary ammonium bromides and quaternary ammonium methyl sulfates. Additionally, amphoteric salts may be useful to change the ion characteristics based on the pH and ions present in a solution, thus allowing reaction with the contaminant species to form a new compound that can be immobilized and/or removed. Examples of such amphoteric salts include, but are not limited to, those containing nitrogen such as alkyl amidopropyl betaines, alky ampho acetates and alky ampho propionates. Further, cationic and amphoteric surfactants may also function as a flocculent that increase the molecular weight of the contaminant species being immobilized and/or removed. Anionic and nonionic surfactants can also enable the dispersion of borates to facilitate transfer into the porous regions of the sorbent material.

In an embodiment, a method for the manufacture of the multi-functional composition of matter is disclosed.

The manufacturing process begins with a carbonaceous feedstock such as low-rank lignite coal, sub-bituminous coal, bituminous coal, or a combination thereof with a relatively high content of natural deposits of native minerals. The feedstock may be agglomerated by mixing the feedstock material and in some cases, crushing, compacting, or extruding the mixture. In the manufacturing process, the agglomerated feedstock is subjected to an elevated temperature and one or more oxidizing gases under exothermic conditions for a period of time to sufficiently increase surface area, create porosity, alter surface chemistry, and expose and exfoliate native minerals previously contained within feedstock. The specific steps in the process include: (1) dehydration, where the feedstock is heated to remove the free and bound water, typically occurring at temperatures ranging from 100-150 C; (2) devolatilization, where free and weakly bound volatile organic constituents are removed, typically occurring at temperatures above 150° C.; (3) carbonization, where non-carbon elements continue to be removed and elemental carbon is concentrated and transformed into random amorphous structures, typically occurring at temperatures around the 350-800° C.; and (4) activation, where steam, air or other oxidizing agent is added and pores are developed, typically occurring at temperatures above 800° C. The manufacturing process may be carried out, for example, in a multi-hearth or rotary furnace. The manufacturing process is not discrete and steps can overlap and use various temperatures, gases and residence times within the ranges of each step to promote desired surface chemistry and physical characteristics of the manufactured product. The activated carbon product is then discharged and may be cooled via passivation.

After activation, the product may be subjected to a comminution step to reduce the particle size (e.g., the median particle size) of the product. Comminution may occur, for example, in a mill such as a roll mill, jet mill, ball mill or other like process. Comminution may be carried out for a time sufficient to reduce the median particle size of the thermally treated product to not greater than about 3 micron (for CCP). In some embodiments, the comminution may be carried out to achieve a median particle size not greater than about 10 micron, or between about 0.5 and 8 micron (for colloidal activated carbon). In some embodiments, the comminution may be carried out to achieve a median particle size not greater than about 100 micron, or between about 8 and 100 micron, or greater than about 8 micron (for powdered activated carbon). In some embodiments, the comminution may be carried out to achieve a median particle size not greater than about 2400 micron, or between about 590 to 2400 microns, or greater than about 590 microns (for granular activated carbon). In some embodiments, the sizing may be performed via the use of sieves (8×30 or 12×40 for granular activated carbon), and/or via grinding. In some embodiments, the biproduct of granular activated carbon production may be used for powered activated carbon or CCP production.

In some embodiments, the activated carbon can be adhered to or otherwise attached to a substrate, such as filtration cloth or other reactive or non-reactive (e.g., chemically inert) substrate.

An embodiment of the present disclosure comprises a method of producing small grains of activated carbon for soil and/or groundwater remediation (e.g., via injection) using a wet ball mill process that yields a multi-functional composition as disclosed herein.

Various techniques may be used to combine the base sorbent material with the contaminant-selective agent. In examples, the contaminant-selective agent may typically be in the form of a solution and/or slurry, such as by dissolving the contaminant-selective agent in water. The solution and/or slurry may then be brought into contact with the base sorbent material to coat and/or impregnate the base sorbent material with the solution and/or slurry. One such technique is the incipient wetness technique, wherein the solution is drawn into the pores of the base sorbent material via capillary action. Other techniques include spraying the contaminant-selective agent solution and/or slurry onto the base sorbent material, impregnating the base sorbent material by soaking it in the solution and/or slurry followed by washing steps, reacting the contaminant-selective agent to the surface of the base sorbent material, or immobilizing the contaminant-selective agent on the base sorbent material's surface. Another technique involves injecting the contaminant-selective agent into the liquid, where it would form complexes with the contaminant(s) in solution to subsequently be absorbed by the base sorbent material. In any case, the solution may be dried, if necessary, to remove excess liquid and/or to crystallize the contaminant-selective agent.

In an alternative embodiment, the contaminant-selective agent may be provided in a substantially dry form (e.g., as particulates) and may be admixed with the base sorbent material, such as by combining the two particular components in a mill or in a mixing unit.

In one embodiment, the base carbon material may be combined with the contaminant-selective agent before or after activation of the base carbon material. In an embodiment, the contaminant-selective agent may be combined with the base carbon material before, during, after milling, or a combination thereof. In non-limiting examples, activated carbon may be milled to a powder, then the contaminant-selective agent(s) may be sprayed onto the dry carbon and the sprayed carbon may be added into the wet ball mill and milled to a smaller particle size. In another example, the contaminant-selective agent(s) may be mixed with water and may be added to added to the wet ball mill so that the activated-carbon comprising solution adsorbs the contaminant-selective agent solution while the activated carbon wet ball mills. As such, the contaminant-selective agent(s) may be combined with the base material during comminution in the grinder which may advantageously expose more surfaces of the carbon allowing for attachment of the additive or upon leaving the mill, where the contaminant-selective agent(s) is added as part of an aqueous solution.

In some embodiments, the method used to combine the contaminant-selective agent(s) with the base material may be based on the contaminant-selective agent(s). For example, contaminant-selective agent(s) selected from the group comprising 1,2 hydroxyl groups, 1,2 carboxyl groups, 1,2 carbonyl groups; compounds comprising phenolic hydroxyl and/or carboxylic groups bonded to aromatic rings; and/or compounds comprising an anionic functional group may be combined with the base material at any stage following activation of the carbon (e.g., before, during, or after wet ball milling, or combination thereof), as the contaminant-selective agent(s) selected form this group or likely to be impacted by activation. In another example, contaminant-selective agent(s) selected from the group comprising metal oxides, layered double hydroxides, metal sulfides, and iron (e.g., zero valent iron) may be combined with the base material at any stage (e.g., in the feedstock, before or after activation, before, during, or after wet ball milling, or combination thereof), as the contaminant-selective agent(s) selected form this group or unlikely to be impacted by activation.

In some embodiments, the contaminant-selective agent may be applied to the base material once, or over multiple same or varying applications. In one non-limiting example, the contaminant-selective agent may be applied to the base material by a first application (e.g., incipient wetness technique), then the contaminant-selective agent may be applied to the base material again but by a second application (e.g., spraying). The first and second applications may be applied via the same or different methods. The base material may be allowed to partially or fully dry between applications.

The base material may be combined with one contaminant-selective agent or multiple contaminant-selective agents. In the case of multiple different contaminant-selective agents, the different contaminant-selective agents may be applied to the base material at the same time, or at different times. If applied at different times, the base material may be allowed to partially or fully dry between applications. Additionally, the different contaminant-selective agents may be applied to the base material via the same application methods (e.g., incipient wetness technique, spraying), or different application methods.

In one embodiment, the base sorbent material may be treated before (pretreated) or after being combined with the contaminant-selective agent. For example, the base sorbent material may be pretreated by contacting the base sorbent material with a base or an acid (e.g., HNO3). A base may facilitate the attachment of the contaminant-selective agent (e.g., tartaric acid) to the base sorbent material. In another example, the base sorbent material may be treated by ozonating the surface of the base sorbent material, i.e., by contacting the base sorbent material with an effective amount of ozone. Ozone treatment may advantageously place oxygen groups on the base sorbent material surface (e.g., carbon surface) that have an affinity for the contaminant species, e.g., for boric acid.

The contaminant selective agent(s) can be added to the base material (e.g., activated carbon) or precursor thereof at elevated temperature or wet or dry mixed with the activated carbon at ambient temperature. While not wishing to be bound by any theory, it is believed that the contaminant selective agent is attracted to the activated carbon by a combination of van der Waals forces and pore adsorption.

The multi-functional composition comprises an effective amount of one or more of the contaminant-selective agent(s) to effectuate the removal of elemental and/or speciated contaminants from a medium, including fluid mediums such as an aqueous (water-based) mediums. In one characterization, the multi-functional composition comprises at least about 0.1 wt. % of a contaminant-selective agent, such as at least about 1 wt. % of a contaminant-selective agent, such as at least about 3 wt. % of a contaminant-selective agent, or at least about 5 wt. % of a contaminant-selective agent. In one characterization, the multi-functional composition comprises at least about 10 wt. % of a contaminant-selective agent, such as at least about 20 wt. % of a contaminant-selective agent, such as at least about 25 wt. % of a contaminant-selective agent, or at least about 30 wt. % of a contaminant-selective agent. In once characterization, the concentration of a contaminant-selective agent in the multi-functional composition is not greater than about 80 wt. %, such as not greater than about 70 wt. %, such as not greater than about 60 wt. %, or even not greater than about 50 wt. %. Stated differently, the multi-functional composition comprises between about 0.5 to about 80 wt. %, or more typically about 10 to 70 wt. %, or more typically about 20 to 60 wt. %, or more typically about 25 to 50 wt. % of composition.

In some embodiments, a rheology additive may be applied to the activated carbon product after activation, either before or after cooling. To apply the rheology additive to the carbon, the rheology additive may be dissolved in water or some other solvent to form a rheology additive solution, and the carbon may be added to the solution, and the combined solution may be wet ball milled. The rheology additive works to disperse the particles and may act as a lubricant during the milling process. The rheology additive may be particularly utilized with carbon in CCP form, but may be added to carbon of any form, such as granular or powdered carbon.

In embodiments, a multi-functional rheology additive is utilized at mass ratio of activated carbon to multi-functional rheology additive between about 0.95:0.05 to 0.50:0.50. In embodiments, a multi-functional rheology additive is utilized at mass ratio of activated carbon to multi-functional rheology additive between about 0.90:0.10 to 0.70:0.30. In embodiments, the rheology additive is combined in solution with the activated carbon particles, where the solution comprises between about 5 wt. % and 30% of the activated particles, and more particularly about 15 wt. % of the activated carbon particles, and between about 0 wt. % and 10 wt. % of the rheology additive, and more particularly about 3 wt. % of the rheology additive.

The multi-functional rheology additive may be selected from the group comprising carboxymethyl cellulose, petroleum sulfonates, polyacrylates, polycarboxylates, polynaphthalene sulfonates, sodium lignosulfonates, Hydroxy ethyl cellulose (HEC), Methyl cellulose (MC), Methyl hydroxy ethyl cellulose (MHEC), hydroxy propyl methyl cellulose (HPMC), Hydroxy propyl cellulose (HPC), Ethyl cellulose (EC), Carbomer (polyacrylic acid), and Guar.

Other additives to multi-functional compositions that are known to those skilled in the art may be included within the multi-functional compositions disclosed herein without departing from the scope of the present disclosure.

The multi-functional compositions disclosed herein are particularly useful for the sequestration of contaminants from a contaminated medium, particularly aqueous (water-based) mediums such as groundwater, or soil. Aqueous mediums may include, but are not limited to, waste streams from CCR landfills, metal fabrication and processing (e.g., electroplating), electrical component manufacture, waste streams from mining, shale oil production, oil field brings, battery processing wastewater, and the like.

Thus, the present disclosure also encompasses a method for the treatment of contaminated mediums to immobilize and/or remove contaminants by contacting the medium with the multi-functional composition such as those disclosed herein. In an embodiment, a method for the application (e.g., use) of the multi-functional composition of matter is disclosed. To facilitate the removal of contaminants from a medium, the method includes contacting the medium with the multi-functional composition of matter disclosed herein. In some embodiments, a contaminant-selective agent may be combined with the multi-functional composition of matter, e.g., before being contacted with the medium, as is discussed above. Alternatively, the contaminant-selective agent may be dispersed into the medium before or during contact of the medium with the multi-functional composition, e.g., with a base carbon material that has not been combined with the contaminant-selective agent.

As is known to those of skill in the art, the multi-functional composition including the base carbon and, in some embodiments, the contaminant-selective agent may be contacted with the medium (e.g., waste stream or soil) to immobilize and/or remove contaminants (e.g., inorganic contaminants, such as CCRs, and the like) in a wide variety of ways. For example, the multi-functional composition may be applied to a contaminated site via injection (such as by direct push technology, specialized injection well designs both vertically and horizontally, and hydro and pneumatic fracturing), in situ trenching, or applied via ex situ or above-ground treatment systems (e.g., spraying), or the like. The multi-functional composition may be placed in a cartridge, column, or similar structure through which the aqueous medium flows or rests. In another example, the multi-functional composition may be placed on or within a membrane (e.g., a planar membrane) through which the aqueous medium flows or rests. The activated carbon can be adhered or otherwise attached to a substrate, such as filtration cloth or other reactive or non-reactive (e.g., chemically inert) substrate. The multi-functional composition may also be shaped into an integral structure (e.g., a honeycomb structure, porous carbon blocks) or may be incorporated into such a structure (e.g., a ceramic honeycomb structure). The multi-functional composition may also be used in a permeable reactive barrier, such as where the multi-functional composition is either buried in a trench or is injected into the subsurface to treat contaminated groundwater. The multi-functional composition may also be applied to contaminated soil through mechanical mixing (e.g., tilling or plowing).

In some embodiments, the multi-functional composition including the base carbon and, in some embodiments, the contaminant-selective agent, may be contacted with the medium in a dry form or in solution (e.g., in a slurry, aqueous form). Whether the multi-functional composition is applied in a wet or dry from may be based on the application technique (e.g., in situ, versus ex situ), or based on the particle size of the multi-functional composition.

In some embodiments, the method used to apply the multi-functional composition may be based on the size of the activated carbon particles in the multi-functional composition. For example, injection may be particularly useful for multi-functional compositions comprising powered and colloidal activated carbon. The injection pressure may also be based on the size of the activated carbon particles in the multi-functional composition. For example, a multi-functional composition comprising PAC may require a higher injection pressure than a multi-functional composition comprising CCP (assuming they are being injected to the same location underground). Multi-functional compositions comprising granular, powdered, or colloidal activated carbon may be trenched, but granular activated carbon may be particularly useful for trenching.

The application techniques described herein to apply the multi-functional composition to a contaminated site may be used alone or in various combinations. In some embodiments, multi-functional compositions comprising the same or different sizes or compositions of activated carbons (i.e., PAC, GAC, CCP) may be used in combination at a contaminated site. For example, a multi-functional composition comprising activated carbon of a first size may be trenched at a particular location, and a multi-functional composition comprising activated carbon of a second size may be injected at the same location or a different location, where the first and second sizes are the same or different. In another example, a multi-functional composition comprising activated carbon of a first size may be trenched at a particular location and a multi-functional composition comprising activated carbon of a second size may also be trenched at the same location or at a different location, where the first and second sizes are the same or different. If trenched at the same location, the two multi-functional compositions may be trenched at the same time or at different times (e.g., double treatment). In another example, a multi-functional composition comprising activated carbon of a first size may be injected at a particular location and a multi-functional composition comprising activated carbon of a second size may also be injected at the same location or at a different location, where the first and second sizes are the same or different. If being injected at the same location, the two multi-functional compositions may be injected at the same time or at different times (e.g., double treatment). Additionally, the two multi-functional compositions may be injected with the same injection pressures or different injection pressures.

In some embodiments, the multi-functional compositions comprising activated carbons of the first and second sizes may be combined before being applied to a contaminated site, or applied to the contaminated site separately.

In a non-limiting example, a multi-functional composition comprising granular activated carbon and/or powdered activated carbon may be trenched into the ground near or at the source of the contamination which may serve as a barrier to limit the spread of the contaminants and to assist cleanup efforts. Additionally, one or more other multi-functional compositions may be injected into source contamination area and/or the surrounding contaminated areas, where the multi-functional compositions may comprise powdered and/or colloidal activated carbon.

In another non-limiting example, a multi-functional composition comprising CCP may be injected at a location via a first injection pressure and multi-functional composition comprising PAC may be injected at the same location via a second injection pressure, wherein the first injection pressure is greater than the second injection pressure. The CCP and PAC multi-functional compositions may mix underground. In another non-limiting example, a multi-functional composition comprising CCP may be mixed with multi-functional composition comprising PAC. The mixed multi-functional compositions may then be applied to a contaminated site, such as by injection. The mixed multi-functional composition may be applied to the contaminated site once or multiple times and/or via different techniques. For example, the mixed multi-functional compositions be injected at a location via a first injection pressure and may be injected at the same location via a second injection pressure, wherein the first injection pressure is greater than the second injection pressure, or vice versa. In such cases, the CCP and PAC multi-functional composition may reach different depths in the ground.

In some embodiments, varying multi-functional compositions may be used in combination or in series at a contaminated site based on the contaminants present, the severity and/or type of contamination (e.g., depth of contamination, spread of contamination, groundwater versus soil contamination), etc. In a non-limiting embodiment, a first multi-functional composition may be used to target one or more inorganic contaminants present, a second multi-functional composition may be used to target one or more other inorganic contaminants present, and so on. The first, second, and so on multi-functional compositions may be applied to a contaminated site at the same time or at different times (e.g., sequentially); the varying compositions may be applied at the same location or at different locations (e.g., adjacent, or overlapping); and may be applied via the same method or via different methods (e.g., injection, spraying), or any combination thereof.

An embodiment of the present disclosure comprises a method to remediate groundwater by providing a slurry of water and a multi-functional composition of matter of the present disclosure.

The slurry may comprise a multi-functional rheology additive and/or dispersion aid at mass ratio of activated carbon to multi-functional rheology additive between about 0.95:0.05 to 0.50:0.50. In some embodiments, the slurry may also comprise a multi-functional rheology additive and/or dispersion aid at mass ratio of activated carbon to multi-functional rheology additive between about 0.90:0.10 to 0.70:0.30. The multi-functional rheology additive and/or dispersion aid may be selected from the group comprising carboxymethyl cellulose, petroleum sulfonates, polyacrylates, polycarboxylates, polynaphthalene sulfonates, sodium lignosulfonates, Hydroxy ethyl cellulose (HEC), Methyl cellulose (MC), Methyl hydroxy ethyl cellulose (MHEC), hydroxy propyl methyl cellulose (HPMC), Hydroxy propyle cellulose (HPC), Ethyl cellulose (EC), Carbomer (polyacrylic acid), and Guar.

The effluent to be treated can be predominantly liquid-phase by volume. Stated differently, the effluent typically comprises more than about 50% by volume liquid and even more typically more than about 75% by volume liquid. The effluent can comprise entrained particles, such as a slurry.

The multi-functional composition is injected into the ground as a slurry that is comprised of the composition of matter plus water.

In some embodiments, such as in situ applications, the multi-functional composition may remain in the soil adsorbing or otherwise immobilizing contaminants from the contaminant plume or groundwater passing through the soil. In some embodiments, the multi-functional composition may be removed from a contaminated site, where the contaminants may also be removed from the contaminated site.

In certain characterizations, the multi-functional compositions disclosed herein have a relatively high capacity for contaminant immobilization and/or removal. In one embodiment, the multi-functional compositions have a capacity to immobilize and/or remove at least about 1 μg contaminant per gram of multi-functional composition (μg C/g), such as at least about 2 μg C/g, at least about 5 μg C/g, at least about 7.5 μg C/g, at least about 10 μg C/g, at least about 15 μg C/g, or even at least about 20 μg B/g. However, it should be understood that removal capacity of the multi-functional compositions may vary widely depending on the target contaminant, the target contaminant concentration, any other present contaminants and their concentrations.

Without being bound by theory, it is believed that the inorganic contaminants targeted herein comprise metals that may carry a valent state, such that they comprise a charge. Additionally, it is believed that the multi-functional compositions comprise charged or chemically functional polar sites. As such, the target inorganic contaminants may readily bind with a multi-functional composition having appropriate characteristics (e.g., opposite surface charge to the contaminant charge, sufficient pore size) via ionic complexing and/or adsorption. The contaminants may therefore be bound to the multi-functional composition for removal (i.e., sequestration).

Additionally, without being bound by theory, the base material of the multi-functional composition disclosed herein typically is alkaline (e.g., comprising a pH greater than about 7, such as about 8, about 9, about 10, or greater) while contaminated sites, such as contaminated groundwater, can be acidic (e.g., with a pH of about 4 to 5). It is believed that the multi-functional composition, upon application to a contaminated site, may act as a buffer to raise the pH of the site. In one non-limiting example, the multi-functional composition may raise the pH of the site to about 6, about 7, or about 8. Typically, inorganic contaminants (e.g., cobalt, arsenic, lithium, contaminants other than molybdenum) are more mobile under acidic conditions. Therefore, increasing the pH (to more alkaline, less acidic) will decrease or demobilize at least some inorganic containments. It is believed that decreased mobility of the inorganic contaminants and/or the increased pH may decrease solubility, aid in precipitating out the inorganic contaminants from a contaminated site, and/or aid in the inorganic contaminants binding to existing metals in the contaminated site. Additionally or alternatively, the decreased mobility and/or the increased pH may improve the ability of the multi-functional composition to adsorb the inorganic contaminants. There is, however, a balance is raising the pH of the contaminated site. For example, it is generally preferable to keep the contaminated site from reaching an alkaline state. Ideally, the pH of the contaminated site would be raised from acidic to slightly above neutral, such as by the addition of the multi-functional composition disclosed herein.

The multi-functional compositions of the present disclosure may be formulated to immobilize and/or remove one or more inorganic contaminants even when the target contaminant(s) is present with such other contaminants, such as organic contaminants. In another characterization, the multi-functional composition may be formulated to target a specific contaminant, to target multiple specific contaminants, or to immobilize and/or remove any and all inorganic contaminants for removal and/or capture.

While various embodiments of a multi-functional composition, a method for the manufacture of a multi-functional composition and a method for removing inorganic contaminants from contaminated mediums have been described in detail, it is apparent that modifications and adaptations of those embodiments will occur to those skilled in the art. However, it is to be expressly understood that such modifications and adaptations are within the spirit and scope of the present disclosure.

### EXAMPLES

### Example 1: Base CCP Adsorption Performance

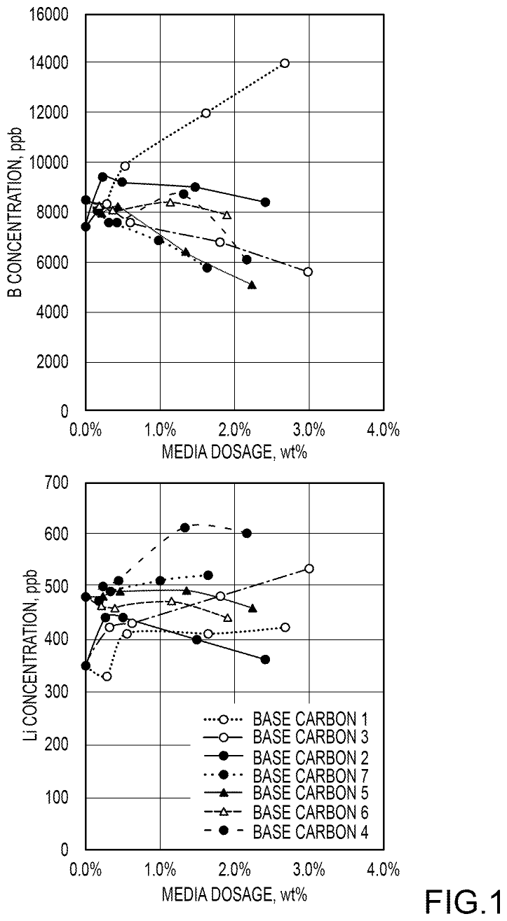

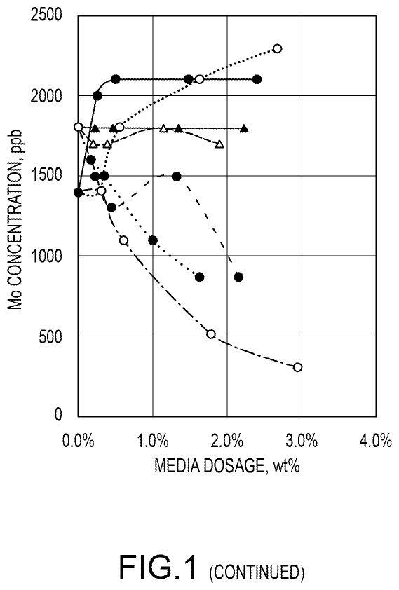

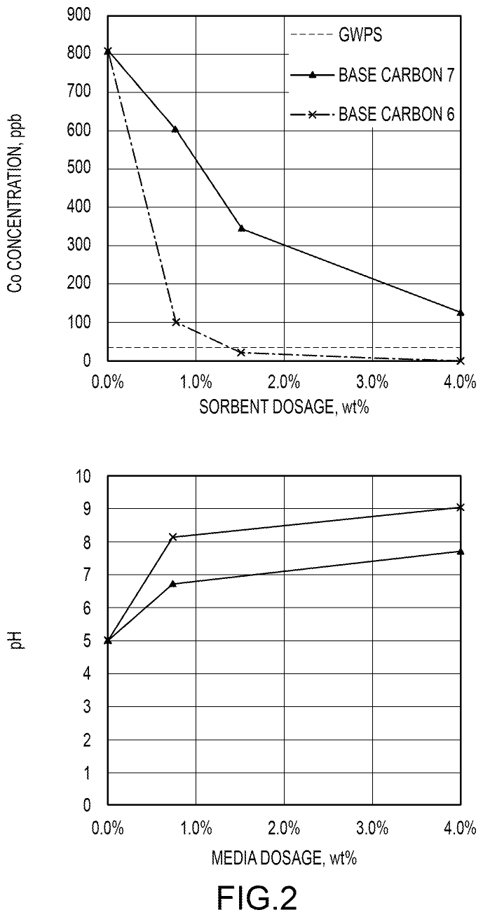

The adsorption performance of seven base CCPs were analyzed through batch testing. Tests were performed in plastic bottles using synthetic groundwater consisting of about 350 mg/L total dissolved solids as instant ocean sea salt and spiked concentrations of boron, molybdenum, and lithium at about 10,000 μg/L, 2,000 μg/L, and 500 μg/L, respectively. The samples were placed on a shaker table for about three days then filtered with a 0.45 μm filter and the treated water was sent to Eurofins Test America Laboratories for analysis by ICP method 200.8. The results are presented in FIGS. 1 and 2. The properties of the synthetic groundwaters tested are presented in Table 2.

TABLE 1
Properties of activated carbons tested.

| | | | | | | | Micro | Concen. |
|---|---|---|---|---|---|---|---|---|
| | | | | | Small | | to Small | Surface |
| | | | | Micro- | Meso- | Total | Meso | Oxygen |
| AC | Iodine | Slurry | Ash | Porosity | Porosity | Porosity | Porosity | Functional |
| Designation | Number | pH | Content | (<20 Å) | (20-150 Å) | (<500 Å) | Ratio | Groups |
| 1 | 520 | 12.1 | 33 | 0.2 | 0.15 | 0.56 | 1.33 | 0.95 |
| 2 | 1050 | 2.3 | 5.2 | 0.47 | 0.57 | 1.28 | 0.82 | 6.2 |
| 3 | 980 | 10.3 | 8.4 | 0.33 | 0.17 | 0.57 | 1.94 | 0.38 |
| 4 | 1000 | 10.2 | 5 | 0.39 | 0.23 | 0.69 | 1.70 | 0.19 |
| 5 | 1300 | 9.7 | 4.4 | 0.69 | 0.19 | 0.92 | 3.63 | 0.99 |
| 6 | 1070 | 12.5 | 13 | 0.43 | 0.19 | 0.67 | 2.26 | 3.5 |
| 7 | 1000 | 10 | 11.6 | 0.37 | 0.25 | 0.69 | 1.48 | 0.52 |

Certain base carbons alone have the affinity to adsorb the constituents of interest. Particularly important in selecting a base carbon is the extractable mineral content of the base activated carbon as well as the slurry pH.

Partitioning of many CCR contaminants between soil and water phases is largely dependent on pH. Generally, constituents (including arsenic and cobalt) are more mobile at lower pH. AC products with inherent minerals that result in a high slurry pH can act as a buffer to aid in the immobilization of constituents of concern. For example, in FIG. 2, cobalt is removed to a greater extent by base AC 6 than AC 7 because AC 6 raises the solution pH from 5 to above 8. In groundwater, AC can not only provide surface area for adsorption and ion-complexing, but it can also act as a buffer to aid in the demobilization of constituents of concern. For example, the buffering ability of the AC can aid in adsorption and/or co-precipitation of cobalt to iron and manganese (oxy)hydroxides, clays, and aluminosilicates both in the AC and in the soil. By increasing the pH above approximately 8.2, the AC can also aid in cobalt precipitation as metal hydroxide.

### Example 2: Modified CCP Formulations

Constituent-selective additives were incorporated into CCP base formulations. To target each constituent of interest, components known to form complexes, adsorb, and/or increase the affinity of the activated carbon for the constituent of interest were added to the formulation. To target boron, polyol additives of sorbitol and N-Methyl-D-Glucamine were added to the carbon formulation. To target lithium, metal oxides and sulfides known to have an affinity for lithium were added to the carbon formulation. To target molybdenum, metal oxides, metal sulfides, layered double hydroxides, and zero valent irons were added to the carbon formulation. To target cobalt, metal oxides, metal sulfides, layered double hydroxides, and zero valent irons as well as organic ligands and anionic functionalities were added to the carbon formulation.

Prototypes are produced in a number of ways. In some instances, the additive is sprayed onto the activated carbon surface prior to the wet ball milling process that converts the activated carbon into a CCP form. In other instances, a solid additive is added to the solution during the wet ball milling process such that the activated carbon and the additive are co-milled. In other cases, a liquid additive is added to the wet ball milling process. In other cases, reactants known to precipitate to form the additive are added to the solution with activated carbon while wet milling and the additive is formed during the wet ball milling process. In other cases, the additive can be added to the base CCP post milling. In other cases, the activated carbon is treated, for example by an acid washing and rinsing protocol, prior to being wet ball milled.

TABLE 2
Summary of prototypes tested and associated production methods.

| Formulation # | Formulation Description | Method of Production |
|---|---|---|
| A | Base CCP + 8% Sorbitol | Additive sprayed onto the base activated |
| | PAC | carbon |
| B | Base CCP + 12% N-Methyl- | Additive sprayed onto the base activated |
| | D-Glucamine CCP | carbon |
| C | Base CCP + Aluminum Oxide | Additive co-milled with the activated |
| | 50/50 | carbon |
| D | Base CCP + Hydrotalcite | Additive co-milled with the activated |
| | 50/50 | carbon |
| E | Base CCP + Ettringite | Precipitation reaction reactants added |
| | 50/50 | to the wet ball mill |
| F | Base CCP + Mackinawite | Additive co-milled with the activated |
| | V1 50/50 | carbon |
| G | Base CCP + Mackinawite | Additive co-milled with the activated |
| | V1 97/3 | carbon |
| H | Base CCP + Zero Valent | Additive co-milled with the activated |
| | Iron 50/50 | carbon |
| I | Base CCP + Mackinawite | Additive co-milled with the activated |
| | V2 50/50 | carbon |
| J | Base CCP + 10% Tannic | Additive co-milled with the activated |
| | Acid | carbon |
| K | Base CCP + 33% | Additive added as a liquid to the wet |
| | Lignosulfonate | ball mill process |
| L | Base CCP + Sodium | Additive co-milled with the activated |
| | Metatitanate 50/50 | carbon |
| M | Base CCP Acid Washed | Base activated carbon treated prior |
| | and Rinsed | to being milled |
| N | Base CCP + 9.6% N- | AC and additives co-ball milled |
| | methyl-D-Glucamine + | |
| | 20% Activated Al2O3 | |
| O | Base CCP + 20% | AC and additive co-ball milled |
| | Activated Al2O3 | |
| P | Base CCP + 20% TiO2 | AC and additive co-ball milled |

### Example 3: Performance of Modified CCP Formulations

The adsorption performance of modified CCPs was evaluated through batch testing. One set of tests was performed in plastic bottles using synthetic groundwater consisting of about 350 mg/L total dissolved solids as instant ocean sea salt and spiked concentrations of boron, molybdenum, and lithium. A second set of tests was performed in plastic bottles using CCR-impacted groundwater samples. The samples were placed on a shaker table for about 3 days in synthetic water and for about 2 weeks in CCR-impacted groundwater. After mixing, the samples were filtered with a 0.45 μm filter and the treated water was sent to Eurofins Test America Laboratories for analysis by ICP method 200.8.

TABLE 2
Properties of the CCR-impacted groundwater samples used for jar tests.

| | | | Initial | Initial | Initial | Initial | Initial | Initial | Initial |
|---|---|---|---|---|---|---|---|---|---|
| | | ORP | B Conc. | Mo Conc. | Li Conc. | Co Conc. | Se Conc. | As Conc. | Be Conc. |
| | pH | (mV) | (ppm) | (ppb) | (ppb) | (ppb) | (ppb) | (ppb) | (ppb) |
| GWPS | — | — | 4 | 100 | 40 | 32 | 50 | 10 | 4 |
| 1 | 7.2 | 234 | 1.8 | 250 | 5.5 | 1.7 | ND | ND | ND |
| 2 | 5.2 | 303 | 10 | ND | 3.3 | 240 | 10 | 1.5 | 0.52 |
| 3 | 4.5 | 309 | 7.5 | ND | ND | 55 | 9.3 | ND | 1.1 |
| 4 | 7.9 | 182 | 0.5 | ND | 45 | ND | ND | 0.94 | ND |
| 5 | 6.1 | — | 0.7 | NT | NT | 0.89 | NT | ND | NT |
| 6 | 6.1 | — | 7 | NT | NT | 0.26 | NT | 25 | NT |
| 7 | 8.2 | 202 | 38 | ND | 1400 | 160 | 440 | ND | 4 |
| 8 | 5.2 | 303 | 1.8 | 560 | ND | ND | ND | ND | ND |
| 9 | 3.9 | 553 | 0.84 | ND | 81 | 280 | 1.7 | ND | 6.5 |
| 10 | 5 | 356 | 3.4 | ND | 13 | 800 | 32 | 15 | 6.6 |

*ND = non-detect
** NT = not tested

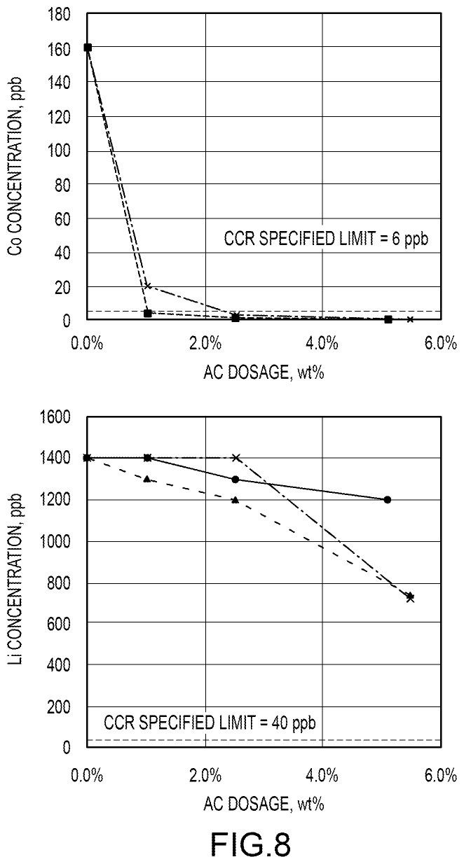

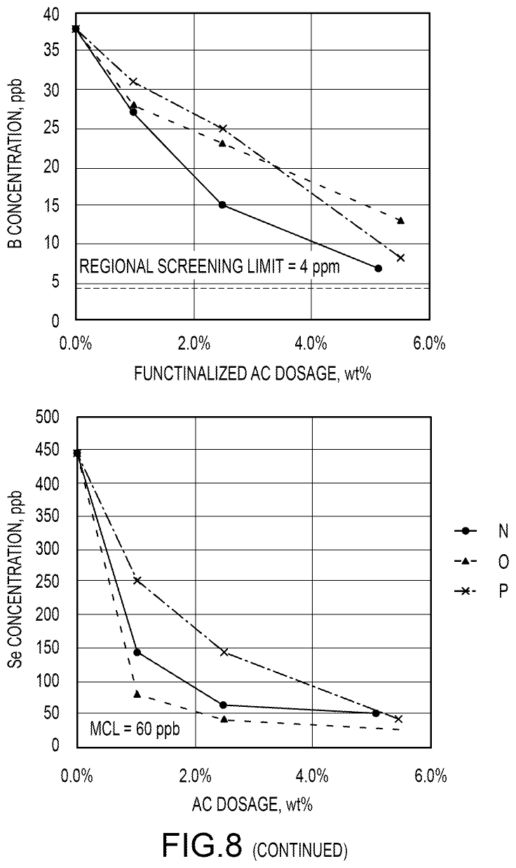

In some embodiments, for the removal of two constituents with the same AC formulation, two selective functionalities are required. FIG. 8 displays removal curves for B, Co, Li, and Se from CCR-impacted groundwater number 7. For CCR-impacted groundwater 7 optimal removal of both boron and selenium is achieved with formulation N.

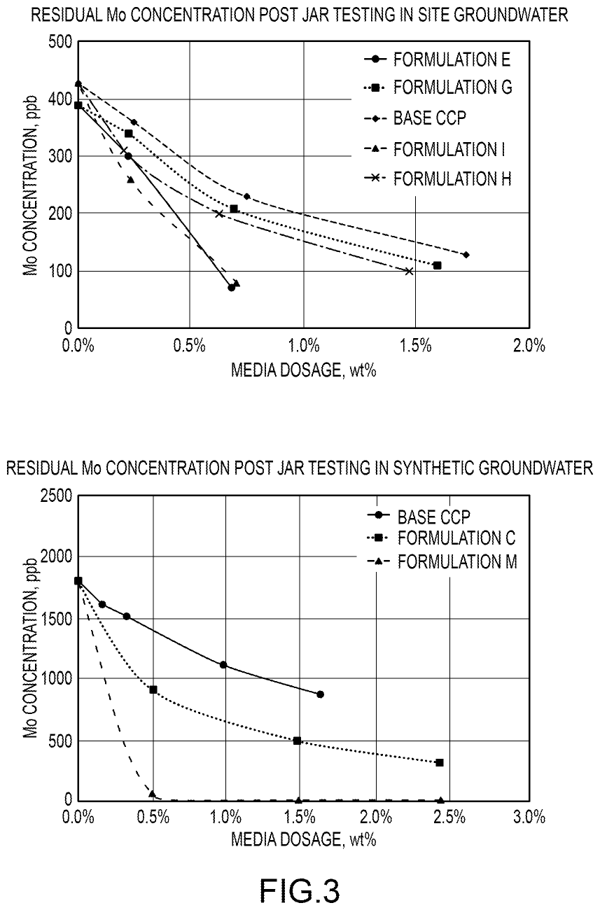

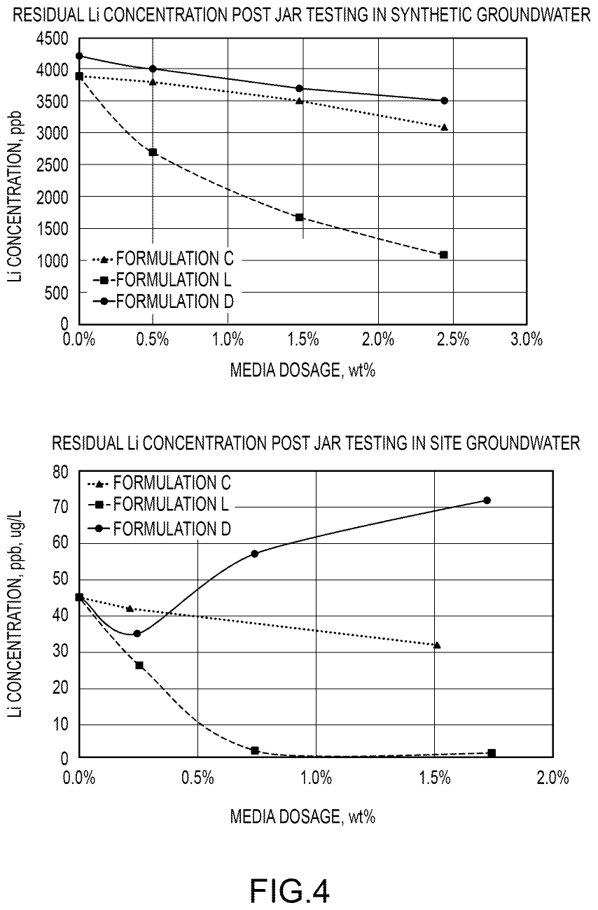

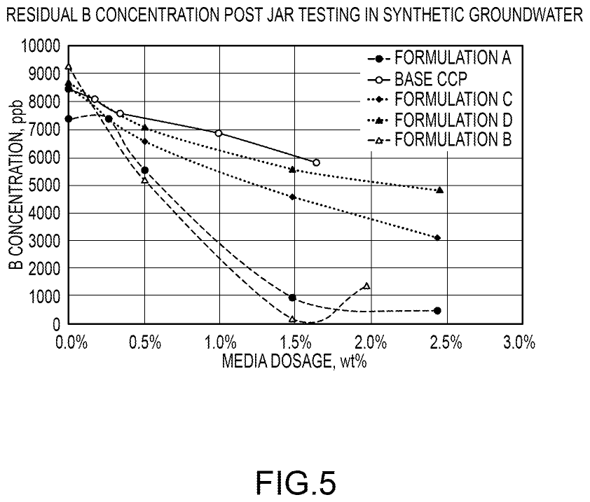

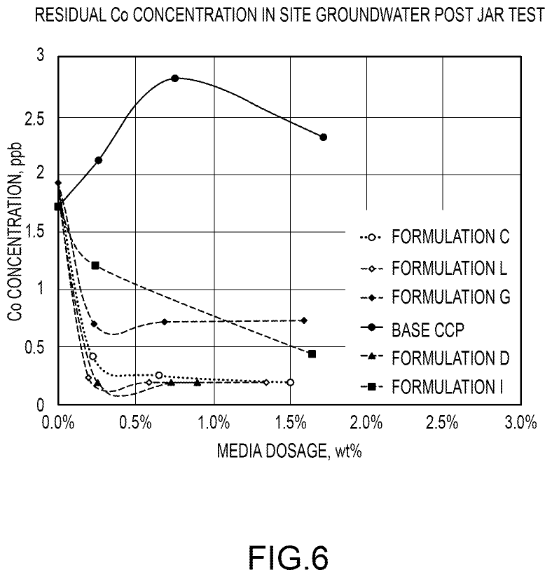

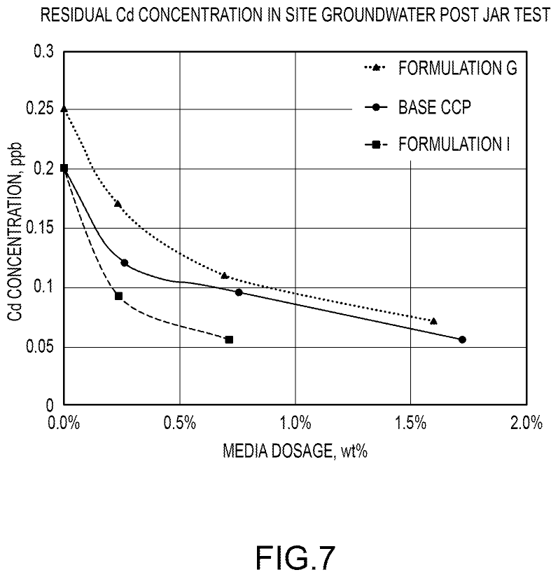

FIGS. 3 through 7 present residual contaminant concentrations (i.e., molybdenum, lithium, boron, cobalt, and cadmium, respectively) in water (e.g., site groundwater or synthetic groundwater) after being subjected to jar testing.

FIG. 8 presents dose removal curves for N, O, and P formulations in CCR-impacted groundwater number 7.

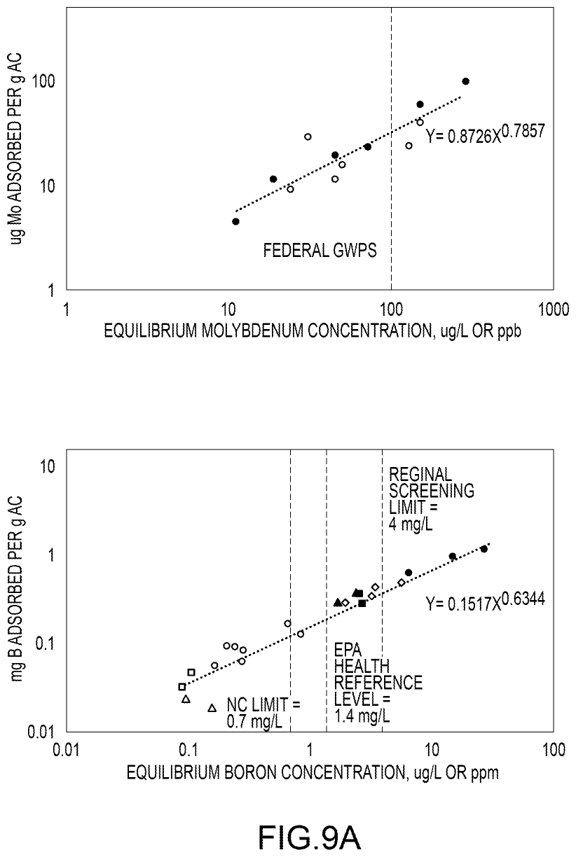

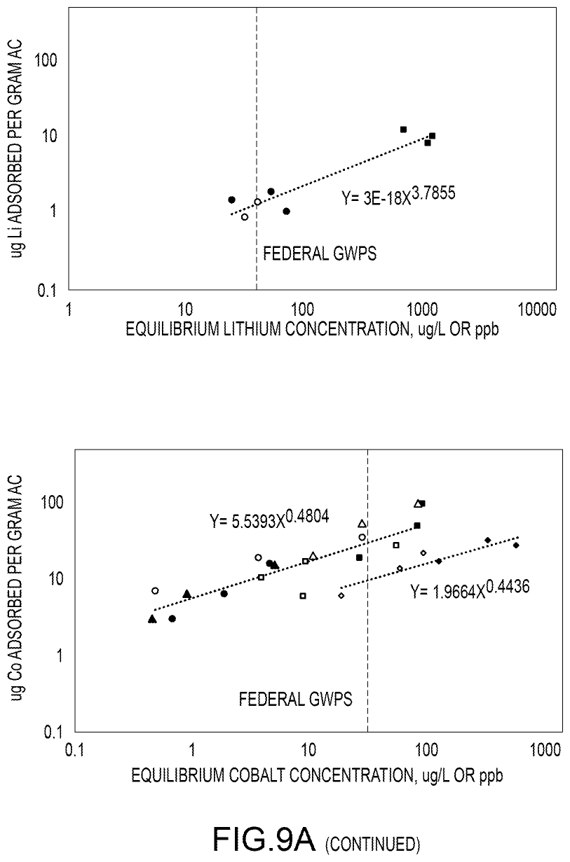

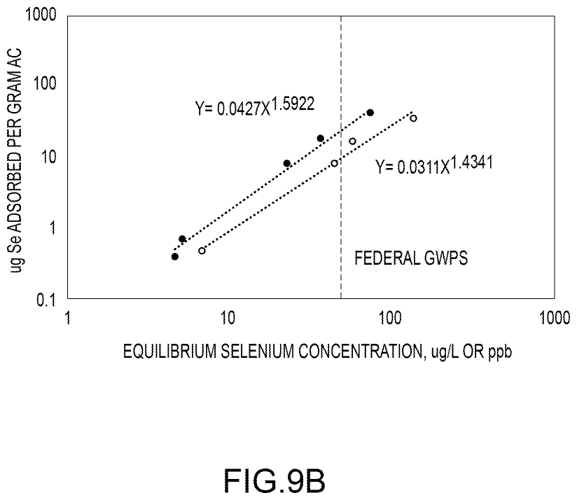

FIG. 9 presents batch adsorption testing results for the two modified ACs in ten CCR-impact groundwater samples. A Freundlich isotherm model was established for each water-sorbent pair (power line of best fit to correlate the adsorbed constituent concentration on the AC to the concentration still in the water phase at equilibrium). Consistent isotherm results were observed across unique groundwater sources regardless of differing initial concentrations, pH values, and concentrations of competing constituents.

Removal results for arsenic and beryllium are not shown as most equilibrium concentrations measured were below the analytical detection limits. Still, arsenic was detected above its GWPS in two water samples, and both the modified ACs reduced concentrations to less than 3.1 ppb in both water samples. Similarly, beryllium was detected above the GWPS in three groundwater samples and both modified ACs reduced concentrations to below the detection limit (<0.27 ppb). In addition, while none of the waters tested to date have exceeded the GWPS for cadmium, lead, chromium, or fluoride, both AC formulations showed adsorption affinity in at least one case for each constituent.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below.

A number of variations and modifications of the invention can be used. It would be possible to provide for some features of the invention without providing others.

The present invention, in various embodiments, configurations, or aspects, includes components, methods, processes, systems and/or apparatus substantially as depicted and described herein, including various embodiments, configurations, aspects, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A multi-functional composition of matter for immobilizing inorganic constituents in contaminated mediums, comprising activated carbon particles, wherein:
about 50% by weight of the activated carbon particles are less than about 3 micrometers,
about 90% by weight of the activated carbon particles are less than about 5 micrometers,
a particle number density of the multi-functional composition of matter is at least about a trillion particles per gram, and
an external surface area density of the multi-functional composition of matter is at least about 3 square meters per gram.

2. The multi-functional composition of matter of claim 1, wherein about 50% by weight of the activated carbon particles are less than about 2 micrometers.

3. The multi-functional composition of matter of claim 1, wherein about 50% by weight of the activated carbon particles are less than about 1 micrometer.

4. The multi-functional composition of matter of claim 1, wherein about 90% by weight of the activated carbon particles are less than about 4 micrometers.

5. The multi-functional composition of matter of claim 1, wherein about 90% by weight of the activated carbon particles are less than about 3 micrometers.

6. The multi-functional composition of matter of claim 1, wherein the external surface area density of the multi-functional composition of matter is at least about 1.5 square meters per gram.

7. The multi-functional composition of matter of claim 1, comprising at least about 50 wt. % and not greater than about 97 wt. % fixed carbon.

8. The multi-functional composition of matter of claim 7, comprising at least about 1.5 wt. % and not greater than 50 wt. % minerals.

9. The multi-functional composition of matter of claim 1, wherein the activated carbon particles comprise a sum of micropore volume plus mesopore volume that is at least about 0.1 cc/g.

10. The multi-functional composition of matter of claim 1, wherein the activated carbon particles comprise a sum of micropore volume plus mesopore volume that is at least about 0.2 cc/g.

11. The multi-functional composition of matter of claim 1, wherein the activated carbon particles comprise a ratio of micropore volume-to-mesopore volume that is at least about 0.35 and not greater than about 3.

12. The multi-functional composition of matter of claim 1, wherein the activated carbon particles comprise a ratio of micropore volume-to-mesopore volume that is at least about 0.4 and not greater than about 2.5.

13. The multi-functional composition of matter of claim 1, wherein the activated carbon particles comprise a ratio of micropore volume-to-mesopore volume that is at least about 0.45 and not greater than about 1.9

14. The multi-functional composition of matter of claim 1, wherein the activated carbon particles comprise a thermal gravimetric analysis (TGA) weight loss, between 400-750° C., of less than about 5 wt. %, less than about 4 wt. %, or less than about 3 wt. %.

15. The multi-functional composition of matter of claim 1, wherein the multi-functional composition of matter is combined with water to form a slurry, and wherein the slurry is alkaline comprising a pH greater than about 10.

16. The multi-functional composition of matter of claim 1, comprising one or more contaminant-selective agents for increasing the ability of the activated carbon particles to immobilize the inorganic constituents in the contaminated mediums.

17. The multi-functional composition of matter of claim 16, wherein the one or more contaminant-selective agents are compounds selected from a group of compounds comprising 1,2 hydroxyl groups, 1,2 carboxyl groups, 1,2 carbonyl groups, and mixtures thereof.

18. The multi-functional composition of matter of claim 16, wherein the one or more contaminant-selective agents are compounds selected from a group of compounds comprising a metal oxide, a layered double hydroxide, a metal sulfide, a zero valent iron, and mixtures thereof.

19. The multi-functional composition of matter of claim 16, wherein the one or more contaminant-selective agents are compounds selected from a group of compounds comprising a phenolic hydroxyl, a carboxylic group bonded to aromatic rings, and mixtures thereof.

20. The multi-functional composition of matter of claim 16, wherein the one or more contaminant-selective agents comprise an anionic functional group.

21. The multi-functional composition of matter of claim 1, wherein the contaminated mediums comprise soil, groundwater, or both.

22. The multi-functional composition of matter of claim 1, wherein the inorganic constituents comprise arsenic, boron, cobalt, lithium, molybdenum, combinations thereof, or other coal combustion residuals.

23. The multi-functional composition of matter of claim 1, comprising diffusion pores and sequestration pores having pore sizes selected based on a molecular size of an inorganic contaminant.

24. A multi-functional composition of matter for immobilizing inorganic constituents in contaminated mediums, comprising activated carbon particles and a contaminant-selective agent, wherein:
the activated carbon particles comprise between about 20 wt. % and about 99.5 wt. % of the multi-functional composition of matter, and
the contaminant-selective agent comprises between about 0.5 wt. % and about 80 wt. % of the multi-functional composition of matter.

25. The multi-functional composition of matter of claim 24, wherein the activated carbon particles comprise between about 30 wt. % and about 90 wt. % of the multi-functional composition of matter.

26. The multi-functional composition of matter of claim 24, wherein the activated carbon particles comprise between about 40 wt. % and about 80 wt. % of the multi-functional composition of matter.

27. The multi-functional composition of matter of claim 24, wherein the activated carbon particles comprise between about 50 wt. % and about 75 wt. % of the multi-functional composition of matter.

28. The multi-functional composition of matter of claim 24, wherein the contaminant-selective agent comprises between about 10 wt. % and about 70 wt. % of the multi-functional composition of matter.

29. The multi-functional composition of matter of claim 24, wherein the contaminant-selective agent comprises between about 20 wt. % and about 60 wt. % of the multi-functional composition of matter.

30. The multi-functional composition of matter of claim 24, wherein the contaminant-selective agent comprises between about 25 wt. % and about 50 wt. % of the multi-functional composition of matter.

31. The multi-functional composition of matter of claim 24, wherein about 50% by weight of the activated carbon particles are less than about 3 micrometers.

32. The multi-functional composition of matter of claim 24, wherein about 50% by weight of the activated carbon particles are less than about 2 micrometers.

33. The multi-functional composition of matter of claim 24, wherein about 50% by weight of the activated carbon particles are less than about 1 micrometer.

34. The multi-functional composition of matter of claim 24, wherein about 90% by weight of the activated carbon particles are less than about 5 micrometers.

35. The multi-functional composition of matter of claim 24, wherein about 90% by weight of the activated carbon particles are less than about 4 micrometers.

36. The multi-functional composition of matter of claim 24, wherein about 90% by weight of the activated carbon particles are less than about 3 micrometers.

37. The multi-functional composition of matter of claim 24, wherein a particle number density of the multi-functional composition of matter is at least about a trillion particles per gram.

38. The multi-functional composition of matter of claim 24, wherein an external surface area density of the multi-functional composition of matter is at least about 3 square meters per gram

39. The multi-functional composition of matter of claim 24, wherein the external surface area density of the multi-functional composition of matter is at least about 1.5 square meters per gram.

40. The multi-functional composition of matter of claim 24, comprising at least about 50 wt. % and not greater than about 97 wt. % fixed carbon.

41. The multi-functional composition of matter of claim 40, comprising at least about 1.5 wt. % and not greater than 50 wt. % minerals.

42. The multi-functional composition of matter of claim 24, wherein the activated carbon particles comprise a sum of micropore volume plus mesopore volume that is at least about 0.1 cc/g.

43. The multi-functional composition of matter of claim 24, wherein the activated carbon particles comprise a sum of micropore volume plus mesopore volume that is at least about 0.2 cc/g.

44. The multi-functional composition of matter of claim 24, wherein the activated carbon particles comprise a ratio of micropore volume-to-mesopore volume that is at least about 0.35 and not greater than about 3.

45. The multi-functional composition of matter of claim 24, wherein the activated carbon particles comprise a ratio of micropore volume-to-mesopore volume that is at least about 0.4 and not greater than about 2.5.

46. The multi-functional composition of matter of claim 24, wherein the activated carbon particles comprise a ratio of micropore volume-to-mesopore volume that is at least about 0.45 and not greater than about 1.9

47. The multi-functional composition of matter of claim 24, wherein the activated carbon particles comprise a thermal gravimetric analysis (TGA) weight loss, between 400-750° C., of less than about 5 wt. %, less than about 4 wt. %, or less than about 3 wt. %.

48. The multi-functional composition of matter of claim 24, wherein the multi-functional composition of matter is combined with water to form a slurry, and wherein the slurry is alkaline comprising a pH greater than about 10.

49. The multi-functional composition of matter of claim 24, wherein the contaminant-selective agent is a compound selected from a group of compounds comprising 1,2 hydroxyl groups, 1,2 carboxyl groups, 1,2 carbonyl groups, and mixtures thereof.

50. The multi-functional composition of matter of claim 24, wherein the contaminant-selective agent is a compound selected from a group of compounds comprising a metal oxide, a layered double hydroxide, a metal sulfide, a zero valent iron, and mixtures thereof.

51. The multi-functional composition of matter of claim 24, wherein the contaminant-selective agent is a compound selected from a group of compounds comprising a phenolic hydroxyl, a carboxylic group bonded to aromatic rings, and mixtures thereof.

52. The multi-functional composition of matter of claim 24, wherein the contaminant-selective agent comprises an anionic functional group.

53. The multi-functional composition of matter of claim 24, comprising a second contaminant-selective agent selected from a group of compounds comprising 1,2 hydroxyl groups, 1,2 carboxyl groups, 1,2 carbonyl groups, a metal oxide, a layered double hydroxide, a metal sulfide, a zero valent iron, a phenolic hydroxyl, a carboxylic group bonded to aromatic rings, an anionic functional group, or mixtures thereof.

54. The multi-functional composition of matter of claim 24, comprising diffusion pores and sequestration pores having pore sizes selected based on a molecular size of an inorganic contaminant.

55. The multi-functional composition of matter of claim 24, wherein the contaminant-selective agent increases the ability of the activated carbon particles to immobilize the inorganic constituents from the contaminated mediums.

56. The multi-functional composition of matter of claim 24, wherein the contaminated mediums comprise soil, groundwater, or both.

57. The multi-functional composition of matter of claim 24, wherein the inorganic constituents comprise arsenic, boron, cobalt, lithium, molybdenum, combinations thereof, or other coal combustion residuals.

58. A method of immobilizing inorganic constituents from contaminated mediums, comprising:
contacting a multi-functionalized activated carbon sorbent with water to form a slurry, wherein the multi-functionalized activated carbon sorbent comprises activated carbon particles and a contaminant-selective agent; and
injecting the slurry into the contaminated medium.

59. The method of claim 58, wherein the slurry comprises a multi-functional rheology additive, dispersion aid, or both at a mass ratio of activated carbon particles to multi-functional rheology additive between about 0.95:0.05 and about 0.50:0.50 or between about 0.90:0.10 and about 0.70:0.30.

60. The method of claim 59, wherein the multi-functional rheology additive, dispersion aid, or both are selected from the group comprising carboxymethyl cellulose, petroleum sulfonates, polyacrylates, polycarboxylates, polynaphthalene sulfonates, sodium lignosulfonates, Hydroxy ethyl cellulose (HEC), Methyl cellulose (MC), Methyl hydroxy ethyl cellulose (MHEC), hydroxy propyl methyl cellulose (HPMC), Hydroxy propyle cellulose (HPC), Ethyl cellulose (EC), Carbomer (polyacrylic acid), and Guar.

61. The method of claim 58, wherein the multi-functionalized activated carbon sorbent comprises two or more contaminant-selective agents.

62. The method of claim 58, wherein the contaminant-selective agent comprises between about 0.5 wt. % and about 80 wt. %, about 10 wt. % and about 70 wt. %, about 20 wt. % and about 60 wt. %, or about 25 wt. % and about 50 wt. % of the multi-functionalized activated carbon sorbent.

63. The method of claim 58, wherein the contaminant-selective agent is a compound selected from a group of compounds comprising 1,2 hydroxyl groups, 1,2 carboxyl groups, 1,2 carbonyl groups, and mixtures thereof.

64. The method of claim 58, wherein the contaminant-selective agent is a compound selected from a group of compounds comprising a metal oxide, a layered double hydroxide, a metal sulfide, a zero valent iron, and mixtures thereof.

65. The method of claim 58, wherein the contaminant-selective agent is a compound selected from a group of compounds comprising a phenolic hydroxyl, a carboxylic group bonded to aromatic rings, and mixtures thereof.

66. The method of claim 58, wherein the contaminant-selective agent comprises an anionic functional group.

67. The method of claim 58, wherein the activated carbon particles comprise about 20 wt. % and about 99.5 wt. %, about 30 wt. % and about 90 wt. % about 40 wt. % and about 80 wt. %, or about 50 wt. % and about 75 wt. % of the multi-functionalized activated carbon sorbent.

68. The method of claim 58, wherein about 50% by weight of the activated carbon particles are less than about 3 micrometers, 2 micrometers, or 1 micrometer.

69. The method of claim 58, wherein about 90% by weight of the activated carbon particles are less than about 5 micrometers, 4 micrometers, or 3 micrometers.

70. The method of claim 58, wherein a particle number density of the multi-functionalized activated carbon sorbent is at least about a trillion particles per gram.

71. The method of claim 58, wherein an external surface area density of the multi-functionalized activated carbon sorbent is at least about 3 square meters per gram, or about 1.5 square meters per gram.

72. The method of claim 58, wherein the multi-functionalized activated carbon sorbent comprises at least about 50 wt. % and not greater than about 95 wt. % fixed carbon.

73. The method of claim 72, wherein the multi-functionalized activated carbon sorbent comprises at least about 1.5 wt. % and not greater than 50 wt. % minerals.

74. The method of claim 58, wherein the activated carbon particles comprise a sum of micropore volume plus mesopore volume that is at least about 0.1 cc/g or at least about 0.2 cc/g.

75. The method of claim 58, wherein the activated carbon particles comprise a ratio of micropore volume-to-mesopore volume that is at least about 0.35 and not greater than about 3, at least about 0.4 and not greater than about 2.5, or at least about 0.45 and not greater than about 1.9.

76. The method of claim 58, wherein the activated carbon particles comprise a thermal gravimetric analysis (TGA) weight loss, between 400-750° C., of less than about 5 wt. %, less than about 4 wt. %, or less than about 3 wt. %.

77. The method of claim 58, wherein the multi-functionalized activated carbon sorbent comprises diffusion pores and sequestration pores having pore sizes selected based on a molecular size of an inorganic contaminant.

78. The method of claim 58, wherein the inorganic constituents comprise arsenic, boron, cobalt, lithium, molybdenum, combinations thereof, or other coal combustion residuals.
